(19) United States
(12) Patent Application Publication
(10) Pub. No.: US 2006/0041534 A1
(43) Pub. Date: Feb. 23, 2006

(54) Remote infrastructure management

(76) Inventor: Micah E. Atwell, Wichita, KS (US)

Correspondence Address: SLATER & MATSIL, L.L.P., 17950 PRESTON RD, SUITE 1000, DALLAS, TX, 75252-5793, US

(21) Appl. No.: 10/852,331

(22) Filed: May 24, 2004

(51) Int. Cl. G06F 17/30; G06F 7/00

(52) U.S. Cl. 707/3

(57) ABSTRACT

System and method for remotely managing communications infrastructures. A preferred embodiment comprises a user remotely situated to a server (e.g. server 205) that is capable of receiving queries from the user, parsing the queries, sending the queries to a desired destination, and transmitting information in response to the queries back to the user. The preferred embodiment further comprises an infrastructure (e.g. infrastructure 210) coupled to the server and a database (e.g. database 220) also coupled to the user, the infrastructure comprising a plurality of network elements and a network connecting the network elements, while the database can be used to store, search, and retrieve information pertaining to the infrastructure. The user can remotely obtain real-time information about the infrastructure as well as control the configuration and operation of network elements, wherein the real-time information about the infrastructure may be obtained through scheduled scanning of the network elements.

### TECHNICAL FIELD

The present invention relates generally to a system and method for infrastructure management, and more particularly to a system and method for remotely managing communications infrastructures.

### BACKGROUND

After a company builds an infrastructure (wired or wireless), such as a communications network, a data network, a security monitoring network, a telemetry network, and so forth, there is a need to manage the infrastructure. Infrastructure management can involve the maintaining, repairing, and servicing of the infrastructure. A part of infrastructure management may involve scheduled tasks, such as replacing equipment after a certain amount of time in the field, upgrading equipment as better performing replacements become available, and so on.

However, another part of infrastructure management may involve unscheduled and unforeseen tasks. For example, a portion of the infrastructure may become damaged through inclement weather, fires, earthquakes, accidents, vandalism, and so on. Alternatively, the infrastructure may not be performing to a level that is satisfactory for a customer. These unscheduled and unforeseen events require that the infrastructure management system be dynamic, i.e., the management system must be able to respond to these unscheduled and unforeseen events.

One way to dynamically manage an infrastructure is through the use of a service center or a call center. A service center can respond by sending out service crews to correct damaged and/or ill-performing equipment. Monitoring equipment can notify service center personnel about damaged equipment while a customer with improperly performing equipment can notify the service center via telephone and/or Internet regarding performance issues. However, a service center that supports a highly advanced infrastructure may be expensive to set up and staff, since the personnel may need to be highly trained and highly paid. Furthermore, dispatching service crews to repair readily fixable problems can also be expensive. Ideally, a service center can be staffed with personnel who are not highly trained or highly paid and these personnel can dispatch service crews, which can be highly trained and highly paid, to correct technical difficulties.

To support the service center, a management system for the infrastructure is needed. The management system can provide status data about the equipment in the infrastructure to the service center personnel. The service center personnel can use the management system to send out service crews to repair malfunctioning equipment. The management system should be real-time or close to real-time so that a malfunctioning piece of equipment will not be operating incorrectly for an extended amount of time. The service center personnel can use the management system to provide support when a user calls in to report performance problems. A rapid resolution of a user's problems can help to build customer satisfaction and loyalty.

In U.S. Pat. No. 6,343,290, a cellular telephone management system that makes use of geographical data is disclosed. The management system consists of a database server, a web server, and a map server. The management system can make use of a database server to retrieve and transmit both network and geographical data to a web server that can display both sets of data into a form that can be readily used by a user. The user can specify certain searches of the network and geographic data, and the map server can format the results of the searches geographically to relay network information to the user. Network data, including status data, can be displayed graphically.

One disadvantage of the prior art is that when a service center used to manage an infrastructure is that the personnel that is usually needed to staff the service center is normally highly trained and highly paid. This can increase the cost of infrastructure management. Ideally, a less well-trained staff should operate a service center and then call for help from highly trained employees when a need arises.

A second disadvantage of the prior art this that the cellular telephone management system is tied to geographical data that can needlessly increase data storage and processing requirements. This can lead to an increased cost in operating a service center. Furthermore, increased storage and processing requirements can also increase the likelihood of the occurrence of problems due to the increased complexity.

### SUMMARY OF THE INVENTION

These and other problems are generally solved or circumvented, and technical advantages are generally achieved, by preferred embodiments of the present invention which provides a system and method for remotely managing an infrastructure.

In accordance with a preferred embodiment of the present invention, a remote infrastructure management system comprises a server remotely coupled to a user, wherein the server is configured to receive queries from the user, parse the queries, send the queries to a desired destination, and to transmit information provided in response to the queries back to the user. The system also includes an infrastructure that is remotely coupled to the server, the infrastructure comprising a plurality of network elements and a network for connecting the network elements. The system further comprises a database that is coupled to the server, wherein the database is configured to store, retrieve, and search information pertaining to the infrastructure and the remote infrastructure management system. Other embodiments of the invention provide other features.

In accordance with another preferred embodiment of the present invention, a method for infrastructure management comprises scanning network element status and displaying the network element status. The method also includes alerting a user if a network element is operating improperly, wherein the user is at a location remote from the infrastructure. The method also comprises allowing the user to control the improperly operating network element. Other embodiments of the invention provide other features.

In accordance with yet another preferred embodiment of the present invention, a method for scanning network elements comprises creating a prioritized scan list based upon network element type and sending a scan message to a highest priority network element in the prioritized scan list. The method also includes processing the scan results and repeating the sending and processing for remaining network elements in the prioritized scan list. Other embodiments of the invention provide other features.

In accordance with another preferred embodiment of the present invention, a method for remote management of a communications network comprises scanning network elements in the communications network and processing the results of the scan. The method also includes alerting a user if a network element is operating improperly and allowing the user to control the improperly operating network element. Other embodiments of the invention provide other features.

An advantage of a preferred embodiment of the present invention is that a tiered level of infrastructure management can be implemented, wherein a staff with less training and lower compensation can perform rudimentary management of the managed infrastructure. The staff can also dispatch better trained and higher compensated technicians when the rudimentary maintenance functions provided by the remote infrastructure management system are not capable of correcting performance issues. Therefore, the cost of infrastructure management can be reduced.

A further advantage of a preferred embodiment of the present invention is that the remote infrastructure management system can automatically and periodically poll infrastructure to determine status. If a problem is detected, the system can notify the staff so that the problem can be fixed.

Yet another advantage of a preferred embodiment of the present invention is that the information regarding the infrastructure can be kept to a minimum so that storage and processing needs can be reduced. This can lead to a more robust system since there are fewer components that can malfunction.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of a service center that can be used to manage an infrastructure;

FIGS. 2a through 2c are diagrams of different network topologies of a remote infrastructure management system;

FIG. 3 is a diagram of a remote infrastructure management system, wherein a public access network can be used to connect various portions of the system, according to a preferred embodiment of the present invention;

FIG. 4 is a flow diagram of the use of a remote infrastructure management system to manage an infrastructure, according to a preferred embodiment of the present invention;

FIGS. 5a and 5b are diagrams of a series of operation in the identity verification process of a user and a screen shot of login screen of a remote infrastructure management system, CWIM, according to a preferred embodiment of the present invention;

FIGS. 6a and 6b are screen captures of initial working screens of the remote infrastructure management system, CWIM, for users with different permission access levels, according to a preferred embodiment of the present invention;

FIGS. 7a through 7d are diagrams of a series of operations in a request of information by a user and screen shots of information provided by the remote infrastructure management system, CWIM, resulting from requests of information by the user, according to a preferred embodiment of the present invention;

FIGS. 8a and 8b are diagrams of a series of operations in a request of information by a user, wherein the user selects an active portion of a graphical image displayed on a display device, and a screen shot of information provided by the remote infrastructure management system, CWIM, resulting from requests of information by the user, according to a preferred embodiment of the present invention;

FIGS. 9a through 9c are diagrams of a series of operations in a request of display change by a user, wherein the user selects an active portion of a graphical image displayed on a display device, and screen shots of the display change provided by the remote infrastructure management system, CWIM, resulting from requests of information by the user, according to a preferred embodiment of the present invention;

FIGS. 10a and 10b are diagrams of a series of operations in a request of information by a user from a managed piece of equipment and a screen shot of information provided by the remote infrastructure management system, CWIM, resulting from requests of information by the user, according to a preferred embodiment of the present invention;

FIG. 11 is a flow diagram of a series of operations in an interrogation of a managed piece of equipment by a user, according to a preferred embodiment of the present invention;

FIGS. 12a through 12c are diagrams of a series of operations in an interrogation of a managed piece of equipment by a user, wherein identity verification is used, and screen shots of information provided by the remote infrastructure management system, CWIM, resulting from requests of information by the user, according to a preferred embodiment of the present invention;

FIG. 13 is a flow diagram of an algorithm for use in scheduling the scanning of equipment in the infrastructure, according to a preferred embodiment of the present invention;

FIG. 14 is a screen capture of configuration settings for the remote infrastructure management system, CWIM, according to a preferred embodiment of the present invention;

FIG. 15 is a screen capture of customer information manipulation for the remote infrastructure management system, CWIM, according to a preferred embodiment of the present invention;

FIG. 16 is a screen capture of information extracted from a database of the remote infrastructure management system, CWIM, according to a preferred embodiment of the present invention;

FIG. 17 is a screen capture of search information for the remote infrastructure management system, CWIM, according to a preferred embodiment of the present invention;

FIG. 18 is a screen capture of update information for the remote infrastructure management system, CWIM, according to a preferred embodiment of the present invention;

FIG. 19 is a screen capture of user login information for the remote infrastructure management system, CWIM, according to a preferred embodiment of the present invention; and

FIG. 20 is a screen capture of user security access permissions for the remote infrastructure management system, CWIM, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a remote management system for a data communications network providing wireless Internet access. The invention may also be applied, however, to other infrastructure, such as other forms of data communications networks, voice communications networks, combination voice and data communications networks, security networks, telemetry networks, and so forth. These networks can be wired or wireless or a combination thereof.

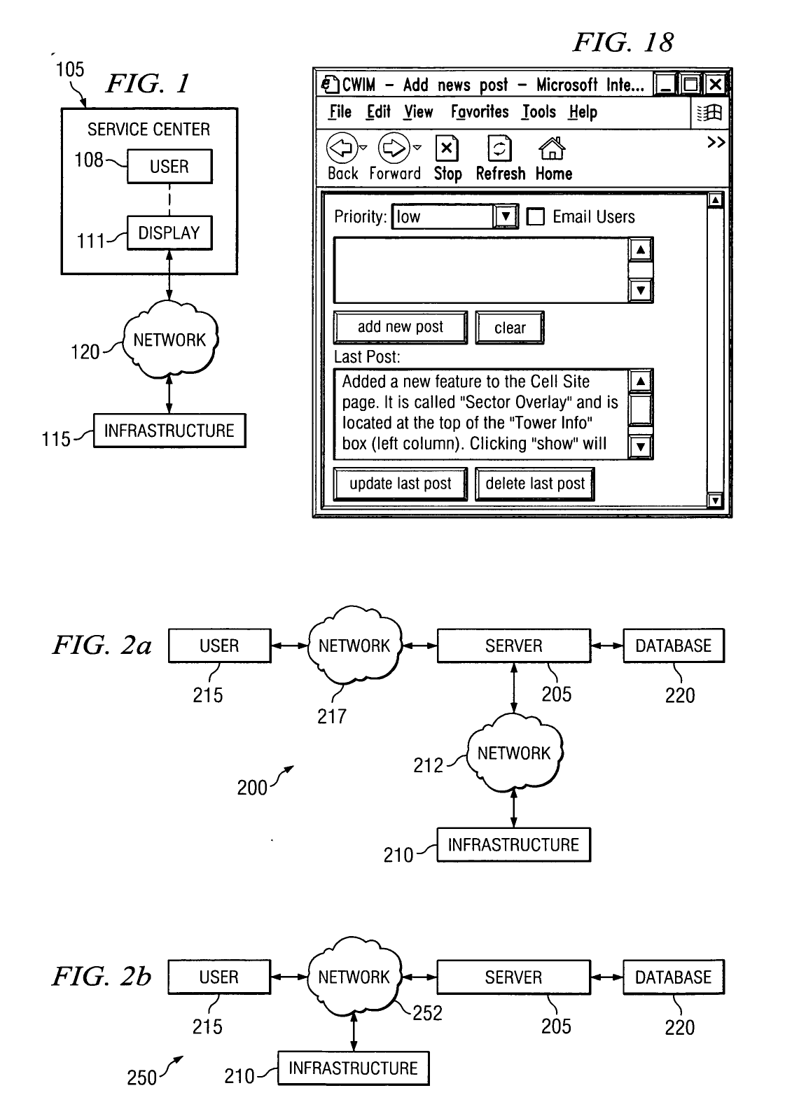

With reference now to FIG. 1, there is shown a diagram illustrating a service center 105 that can be used to manage an infrastructure 115. The service center 105, which can also be known as a customer service center, a call center, a repair center, and so on, can have remote access to the infrastructure 115. The infrastructure 115 may be in close proximity to the service center 105 or it may be widely separated from the service center 105. For example, the infrastructure 115 may be a wireless Internet access network located in a different country from where the service center 105 is located. The service center 105 can be located where it can be easy and inexpensive to find personnel to staff the center. Note that references to the service center 105 can imply that it is a facility staffed by many people and with a large amount of equipment. However, the service center 105 may be as simple as a single person (user 108) at a display device (display 111) that is capable of displaying information about the infrastructure 115.

Connecting the service center 105 to the infrastructure 115 may be a network 120. The network 120 may be a proprietary, private access network that is expressly designed to provide a connection between the service center 105 and the infrastructure. Alternatively, the network 120 may be a part of a public access network, such as the Internet. Furthermore, the network 120 may be a wired network or a wireless network or a combination thereof. Additionally, the network 120 may be a data network overlaying a voice network. For example, the network 120 may be a data network overlaid over a cellular based voice network. The network 120 can be used to move information from the infrastructure 115 to the service center 105 (to the user 108 via the display 111) and vice versa. In addition to information, such as status and performance information, the network 120 can carry control data between the service center 105 and the infrastructure 115. For example, the network 120 can carry control data that can be used to configure equipment (not shown) located in the infrastructure 115.

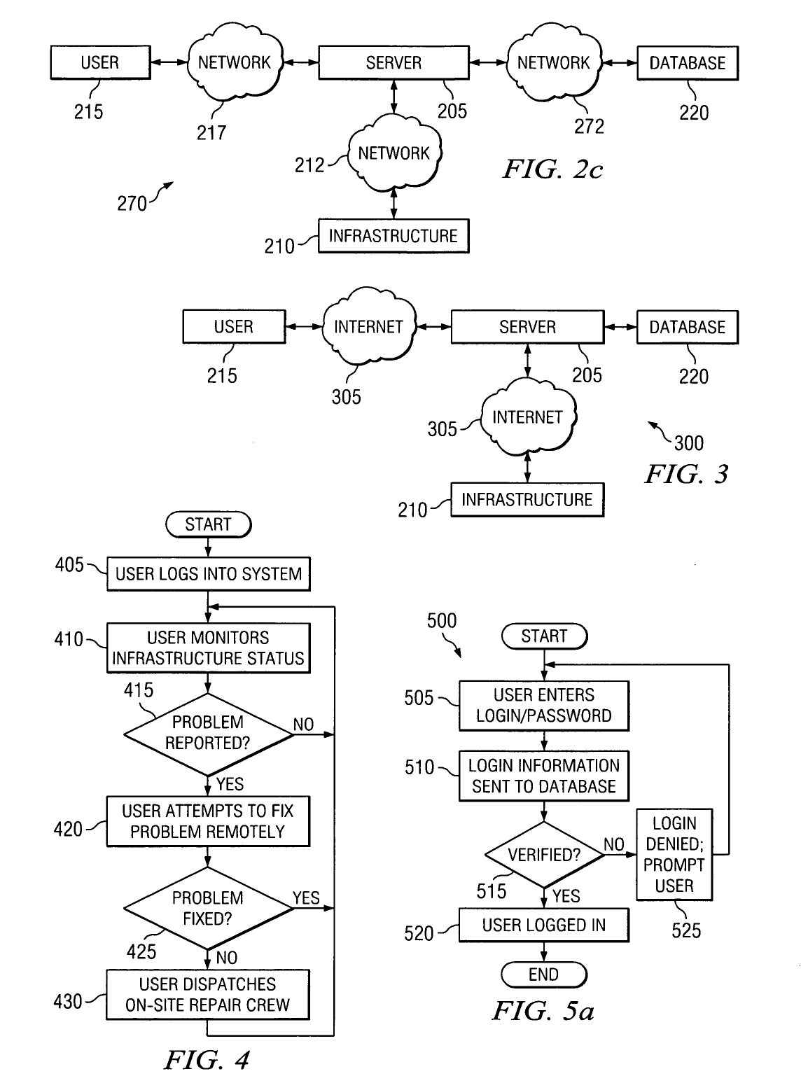

With reference now to FIGS. 2a and 2b, there are shown diagrams illustrating a remote infrastructure management system 200 wherein different network connection topologies are shown, according to a preferred embodiment of the present invention. The remote infrastructure management system 200 comprises a server 205, which can be coupled to an infrastructure 210 via a first network 212. The server 205 may also be coupled to a user 215 by a second network 217. Note that the user 215 may be representative of support staff in a service center. Therefore, the term user and service center may be used interchangeably without modifying the intent of the present invention. The server 205 may also be coupled to a database 220. The server 205 and the database 220 may be part of one entity or they may be separate entities located in a single installation.

In FIG. 2a, separate networks can be used to connect the server 205 to the infrastructure 210 (via the first network 212) and the server 205 to the user 215 (via the second network 217). In FIG. 2b, a single network 252 can be used to provide the needed connectivity between the server 205, the infrastructure 210, and the user 215 in a remote infrastructure management system 250. The use of a single network (network 252) can help reduce implementation costs of the remote infrastructure management system 250 when compared to multiple networks (the first and second networks 212 and 217) used in the remote infrastructure management system 200. Note that while a single network can be used to provide the needed connectivity, it may still be possible to logically partition the network 252 so that functionally, the remote infrastructure management system 250 appears to have different networks connecting the server 205 to the infrastructure 210 and the server 205 to the user 215.

With reference now to FIG. 2c, there is shown a diagram illustrating a remote infrastructure management system 270, according to a preferred embodiment of the present invention. As discussed previously, the database 220 and the server 205 may be part of a single entity, such as a computer wherein the server 205 can be an application executing on the computer while the database 220 can be a storage (such as a disk drive) also located on the computer. Alternatively, the database 220 and the server 205 may be separate entities that can be located within a single location. For example, the server 205 can be a dedicated computer that may be optimized to provide desired performance and the database 220 may be a storage unit with specialized storage devices that can provide good data transfer rates along with data redundancy and other data protection techniques.

When the server 205 and the database 220 are no longer part of a single entity, they too may need to be connected to one another via a network 272. The network 272 may be a localized network if the server 205 and the database 220 are located in a single installation or the network 272 may be part of a large area network if the sever 205 and the database 220 are not housed within a single installation. As discussed above, the network 272 may be a physically disjoint network from the first and the second networks 212 and 217 or it may be a logically disjoint from the first and the second networks 212 and 217 but all three networks may be physically part of a single network.

Note that while displayed as a single unit, the database 220 may be made up of multiple units. For example, the database 220 may be made up of multiple units that are configured to automatically mirror one another to help reduce the probability of data loss. Alternatively, the multiple units may implement a form of data encoding to help improve data access performance. Furthermore, a form of RAID (redundant array of inexpensive disks) may be implemented to improve both data access performance and reduce the probability of data loss.

With reference now to FIG. 3, there is shown a remote infrastructure management system 300, wherein a public access network may be used to connect the various portions of the system, according to a preferred embodiment of the present invention. Rather than using a proprietary or private network to connect portions of a remote infrastructure management system together, a public access network, such as the Internet, can be used. Since portions of a remote infrastructure management system may be widely separated, perhaps countries or continents apart, the installation of a private network can be expensive. Therefore, a public access network, such as the Internet, or a subscription based network using a communications network created by a third party service provider (such as voice/data wireless networks) can be a cost-effective solution.

An Internet-based connection between the server 205 and the infrastructure 210 and the server 205 and the user 215, labeled Internet 305, can offer a cost-effective, flexible, and fault-tolerant connection for the portions of the remote infrastructure management system. Since the Internet is widely available, the user 215 can remotely access the server 205 and the infrastructure 210 from anywhere that has Internet access. For example, the user 215 using appropriate equipment can monitor the status of the infrastructure 210 from a service center, from home, from an Internet café, on-the-road, in-the-air, and so forth. Furthermore, since the Internet is relatively structure-free, should a connection-pathway between the user 215 and the server 205, for example, be severed, another connection-pathway can readily be found, typically automatically. Note that although not shown in FIG. 3, the server 205 and the database 220 may also be coupled via an Internet-base connection.

The infrastructure 210 may contain equipment (not shown) that can be individually and/or collectively addressed. The equipment may be also referred to as network elements. The network elements can be connected to one another and the remainder of the remote infrastructure management system 200 via an interconnection network (not shown). The interconnection network may be wired or wireless or a combination thereof and can permit the network elements to communicate with one another. When wirelessly connected, a wireless connection between network elements can be made using radio frequency (RF), microwave, laser, infrared, and other signaling media (both line-of-sight and non-line-of-sight). The network equipment can have the capability of responding to messages (polls, scans, and so forth) sent from the server 205 and the user 215 (via the server 205). The messages from the server 205 may request information from the equipment (network elements) regarding its status, configuration, performance, and so forth. In addition to providing the requested information in the messages from the server 205, the equipment can also respond to control inputs (in the form of messages) from the server 205. For example, the equipment can be told to perform a reboot operation.

As an example, if the infrastructure 210 should happen to be a wireless Internet access network, then network components can be hubs, backhauls, cell sites or cell towers (in wireless local area networks, cell sites may be referred to as access points), and individual transceivers located at a customer installation. The hubs, backhauls, cell sites, and transceivers can be connected to one another via wired or wireless connections or combinations thereof. For example, a connection between a hub and multiple cell sites may be via a high throughput wired connection while a connection between a cell site and a transceiver may be made by a wireless connection.

With reference now to FIG. 4, there is shown a flow diagram illustrating the use of a remote infrastructure management system 300 to manage an infrastructure, according to a preferred embodiment of the present invention. The remote infrastructure management system 300 can be operated by one or more users located at a service center. Alternatively, if access to the remote infrastructure management system may be made via a public access network, such as the Internet, a user can operate the system via a display device from practically anywhere there is access to the public access network.

After login into the remote infrastructure management system (block 405), the user can monitor the status of the infrastructure 210 (block 410). The status of the infrastructure 210 may be provided to the user automatically or manually. A problem with the equipment can be reported (block 415) in several different ways. A first way may involve a periodic (and automatic) status update, a second way may involve the user detecting a problem during a manually initiated probe, and a third way may involve information provided by a customer (the customer can contact a technical support representative to report a problem). For example, the remote infrastructure management system 300 may be configured to automatically scan the status of equipment in the infrastructure 210 at regular intervals. Automatic scanning may be a good way to keep information about the status of the infrastructure 210 up to date.

A scan of the infrastructure 210 may also be initiated manually by the user. For example, if a scan can be time consuming or expensive, then rather than performing regularly scheduled scans of the infrastructure, the remote infrastructure management system may be configured so that only the user can initiate a scan of the infrastructure 210, such as at an off-hour (in the middle of the night, for example). Finally, the status of the infrastructure 210, may be updated by a report provided by a subscriber. For example, when a subscriber is experiencing sub-par performance (or no service at all), the subscriber may make contact with a service center via voice (telephone) or data (Internet webpage, facsimile, and so on), he/she can report the experience to the user. If no problems are reported, then the user can continue to monitor the status of the infrastructure (block 410).

If the infrastructure 210 is a wireless Internet access network, then examples of problems that the network equipment may face may include low received signal strength (as indicated by the network equipment's received signal strength indicator), a high clock jitter, a low data throughput, high network latency, low network element uptimes, equipment uptime, session count, request to send (RTS) threshold, minimum contention window, average receive signal-to-noise ratio (SNR), and link efficiency, and so forth. These problems (and others) can all contribute to a poorly performing infrastructure 210.

Regardless of how the problem was detected, the user can attempt to fix the problem through diagnostic tools that may be provided by the remote infrastructure management system (block 420). The user may be able fix the equipment in a plurality of many different ways, such as, query the infrastructure 210 for status of the improperly performing equipment, probe the improperly performing equipment for specific information (configuration and performance information, for example), change the configuration of the improperly performing equipment, reset (or reboot) the improperly performing equipment, turn off the improperly performing equipment, and so forth. After using the diagnostic tools, the user can check the status of the malfunctioning equipment (block 425) and if the problem has been corrected, the user can return to monitoring the infrastructure 210. Note that if a subscriber reported the performance problem, the user may be able to attempt to correct the performance problem while remaining in contact with the subscriber. The ability to work interactively with the subscriber to fix the performance problem can help maintain a good relationship with the subscriber, especially if the user is able to remedy the performance problem. Furthermore, it may be possible for the user to use various diagnostic tools at his disposal in an attempt to fix the performance problem. However, if after a number of attempts, the equipment is still not functioning properly, the user can dispatch an on-site repair crew (block 430) to fix the problem equipment. After dispatching an on-site repair crew, the user can return to monitoring the infrastructure 210. Note that after dispatching an on-site repair crew, the improperly performing equipment can be ignored until sufficient time has elapsed for the on-site repair crew has had an opportunity to perform the repair.

As discussed previously, the ability to fix (or at least, attempt to fix) a performance problem remotely, without needing to dispatch an on-site repair crew, can result in a reduction in the cost of managing the infrastructure 210. For example, if a performance problem can be fixed by resetting an improperly operating piece of equipment, then the cost of sending out the on-site repair crew can be eliminated. Furthermore, the resetting of the improperly operating piece of equipment can be performed as soon as the problem was detected, i.e., a delay associated with dispatching the on-site repair crew (perhaps on the order of hours or days) can also be eliminated.

The remote infrastructure management system 300 may operate in several different modes. A first mode of operation may be a verification mode. In the verification mode, the user 215 can be prompted to verify his/her identity. Since the proper operation of the infrastructure 210 can be vital to the company running the infrastructure 210 and to the customers paying for the use of the infrastructure 210, access to the remote infrastructure management system 300 should be controlled in order to prevent unauthorized persons from viewing and/or changing sensitive information that can be present in the remote infrastructure management system 300. Furthermore, if the remote infrastructure management system 300 may be accessed through a public access network (the Internet, for example) then security may be of additional concern.

Since sensitive customer and corporate information as well as secretive information that can provide a competitive advantage may be present in the remote infrastructure management system 300, only authorized personnel should have access to the information. According to a preferred embodiment of the present information, the user 215 may be prompted to verify his/her identity through the entry of username and password. Alternatively, the verification of identity can be performed using biometric techniques, such as finger printing, retina scanning, voice recognition, and so forth. Upon verification, the user 215 may be permitted access to the remote infrastructure management system 300 based upon pre-assigned security levels that may be stored in the database 200. The amount of information accessible by the user 215 (read and write information, alter hardware configuration, and so on) can be given in a layered approach depending upon the user's security level. For example, the user 215 who may be a non-technical employee may be permitted to only read information in certain parts of the remote infrastructure management system 300, but not write any information or alter any hardware configurations, while a system maintenance employee may be granted total access to the remote infrastructure management system 300. Note that for some operations, such as those that can alter the operation of equipment, additional identity verification may be performed to ensure the identity of the user 215 issuing the operation.

A second mode of operation may be an information mode. In the information mode, the user 215 can request information about the infrastructure 210. According to a preferred embodiment of the present invention, the server 205 can parse the information request from the user 215 and retrieve the information requested from the database 220. Depending upon the age of the information stored in the database 220, the server 205 may elect to respond to the information request using the information stored in the database 220 or by specifically requesting the information from the infrastructure 210. This can help to prevent a condition wherein the information stored in the database 220 is no longer current.

A third mode of operation may be an interrogation mode. In the interrogation mode, the user 215 can request information from specific equipment in the infrastructure 210. According to a preferred embodiment of the present invention, the server 205, upon receiving a interrogation poll from the user 215, can provide the interrogation poll to the specified equipment. When the equipment replies to the interrogation poll, the server 205 can provide the response from the specified equipment to the user. The interrogation mode can allow direct communications between the specified equipment and the user 215 without accessing information that may be stored in the database 220.

A fourth mode of operation may be a repair mode. In the repair mode, the user 215 can issue commands that can be executed by specific equipment in the infrastructure 210. The server 205 can send the command to the specified equipment, which can execute the requested command when it receives the command. According to a preferred embodiment of the present invention, the command can include commands to reset, power-cycle, change parameter, change mode, enable/disable functionality, and so on. After the execution of the requested command, the specified equipment can return an acknowledgment to the user 215 that the command was executed (successfully or unsuccessfully). Additionally, any results from the execution of the command may also be returned to the user 215.

A fifth mode of operation may be an automatic mode. In the automatic mode, the server 205 can periodically poll equipment in the infrastructure 210. When the equipment receives a poll, the equipment can respond with requested information. For example, according to a specified period of time, the server 205 may send a poll request to each piece of equipment in the infrastructure 210. When a piece of equipment receives the poll request, it can respond, with the response dependant upon the nature of the poll request. Examples of poll requests may be requests for equipment status, signal strength, up-time, and so on.

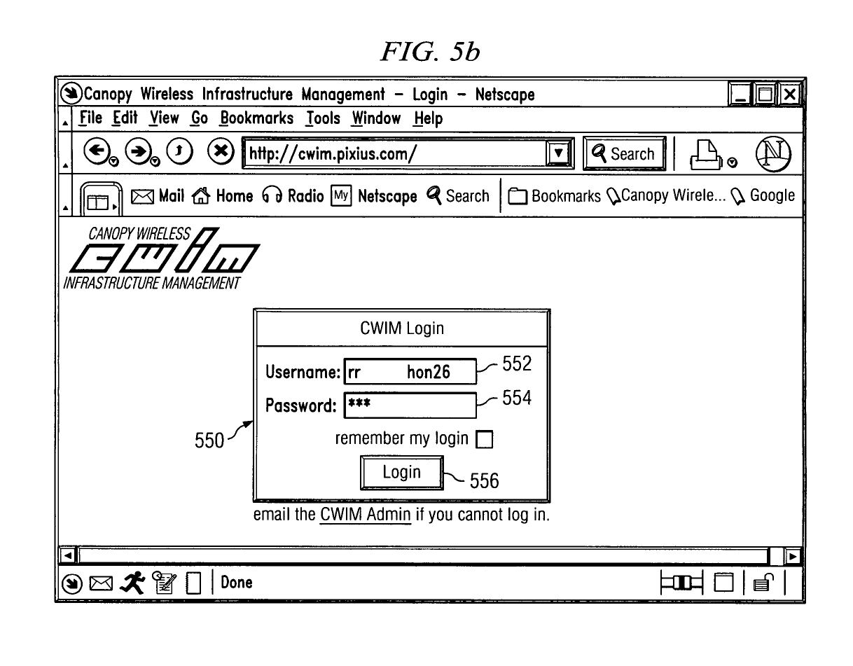

With reference now to FIG. 5a, there is shown a flow diagram illustrating a series of operations 500 in the identity verification process of a user, according to a preferred embodiment of the present invention. As displayed in FIG. 5a, the series of operations 500 verifies the identity of a user via a login and password, wherein if the user enters a valid login and password, access can be granted to the remote infrastructure management system 300. However, other identity verification techniques can also be used, including biometric techniques that can use biological identifiers to verify the identity of the user. The series of operations 500 can be readily modified to make use of these other identification techniques and these changes should be readily evident to a person of ordinary skill in the art of the present invention.

The series of operations 500 can begin when the user enters his/her login and password into a prompt that can be provided by the remote infrastructure management system 300 (block 505). According to a preferred embodiment of the present invention, the user can enter the login and password information on a display terminal that can also be used to display information provided by the remote infrastructure management system 300. However, if the identity verification involves the use of biometrics, a special device may be present to capture the required biometric, such as fingerprint, retina scan, voice capture, and so forth. Note that while not shown, a server (such as the server 205 (FIG. 3)) can be used to facilitate the entry of verification information by the user.

After the user enters the required information (login/password, biometric information, for example), the required information can be sent to a database (such as the database 220 (FIG. 3)) for verification (block 510). The verification may be as simple as comparing the login/password with other logins and passwords stored in the database 220 to a more complex pattern matching operation that may be needed to match the provided biometric information with what is stored in the database 220 (block 515). After the database 220 performs the verification, the user can be logged into the remote infrastructure management system 300 if the verification was successful (block 520). Note that different users may have different security access permissions, with users with low security access permission not being permitted to perform some of the operations that users with higher security access permission.

A user's security access permission can be verified on an operation-by-operation basis (i.e., the user's security access can be verified prior to an operation) or it may be set one time (perhaps during login identity verification) and may remain valid until the user logs out. Note that some of the identity verification operations may be performed by the remote infrastructure management system 300, for example, to allow access to the remote infrastructure management system 300, and some of the identity verification operations may be performed by the network elements in the infrastructure 210, for example, when the user wishes to interrogate a network element.

If the verification was not successful, then the user may be notified that the failed verification and may be prompted to try again (block 525). Again, the server 205 may be used to display the successful or failed identity verification process. A variation of the identity verification process can maintain a count of unsuccessful verifications and if an inordinate number of failed attempts have been recorded, the user may be prevented from additional attempts.

With reference now to FIG. 5b, there is shown a screen capture illustrating an initial identity verification screen for providing access to a remote infrastructure management system, according to a preferred embodiment of the present invention. FIG. 5b displays a screen capture of a prompt for a user to enter his/her login and password to gain access to an exemplary remote infrastructure management system. The exemplary remote infrastructure management system, whose login screen is displayed in FIG. 5b, can be used to control a wireless Internet access network. The wireless Internet access network uses a wireless line-of-sight system known as Canopy and the remote infrastructure management system is known as Canopy Wireless Infrastructure Management (or CWIM for short). Note that CWIM is an implementation of a remote infrastructure management system and a discussion of which should not be construed as limiting the spirit of the present invention.

The CWIM environment, as seen by a user, may be generated by the server 205 using information provided by the database 220 and the infrastructure 210. The server 205, in addition to containing necessary programming to support the various modes of the remote infrastructure management system 300, can also contain necessary programming to draw the environment (such as the CWIM environment) onto a display device used by the user. For example, if the display device is a dumb display device, then the server 205 may necessarily contain the programming to generate the entire environment. If the display device has a certain level of display processing capability, then it may suffice if the server 205 is only capable of generating commands for creating the environment. For example, if the display device being used by the user has an Internet client, then the server 205 can be a relatively simple Internet server, since the Internet client has enough capability to take commands from the server 205 and generate the environment on its own.

CWIM prompts the user to enter his/her login and password by displaying a window 550 in the CWIM environment. The window 550 may have two fields, a first field 552 can be where the user can enter his/her login (referred to as “Username”) and a second field 554 can be where the user can enter his/her password (referred to as “Password”). The window 552 can also have a button 556 (referred to as “Login”) that the user may click to submit the login information to the CWIM environment. After the user clicks on the button 556, the login information may be taken by the server 205 and provided to the database 220 for verification (blocks 505 and 510 from FIG. 5a).

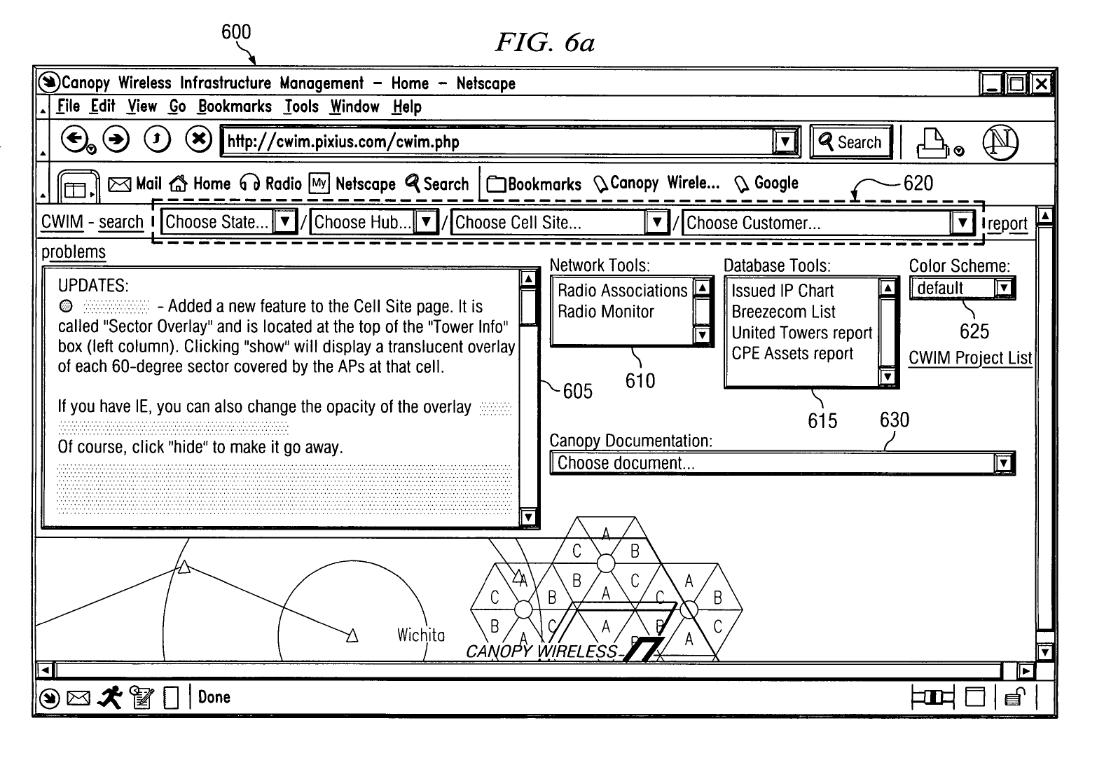

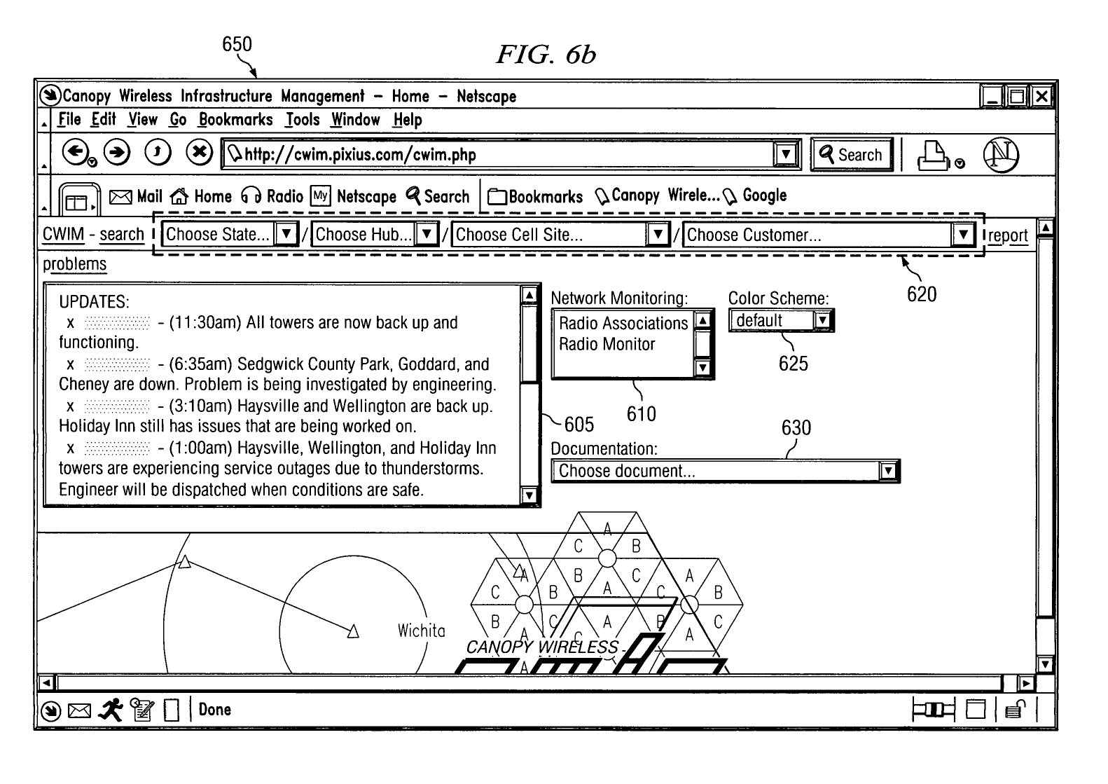

With reference now to FIG. 6a, there is shown a screen capture illustrating an initial working screen 600 of the exemplary remote infrastructure management system, CWIM, wherein a user of the exemplary remote infrastructure management system has a relatively high permission access level, according to a preferred embodiment of the present invention. After verifying the identity of the user, the server 205 may create an initial working screen on the display device of the user. For the CWIM environment, the initial working screen 600 may appear as shown in FIG. 6. The initial working screen 600 may comprise several different regions, with each intended to perform a different task. An update region 605 can be used to provide news and other information to the user about features, fixes, infrastructure status, and so forth. A network tools region 610, which can be referred to as “Network Monitoring” in CWIM, can provide a list of tools that can be available to the user for use in monitoring and managing the infrastructure 210, while a database tools region 615, which can be referred to as “Utilities” in CWIM, can provide a list of tools that the user can use to access information stored in the database 220. A search region 620 can permit the user to retrieve specific information for infrastructure equipment using different search parameters, such as equipment name and customer name, for example. Other regions can permit the user to customize the appearance of the environment (color scheme region 625) and retrieve documentation (documentation region 630). Note that the content of certain regions, such as the network tools region 610 and the database tools region 615, can vary depending upon the identity of the user, i.e., his/her security access level. For example, a user with a low security access level may not be able to access the network tools region 610. Note that some sensitive information may have been obliterated in the screen capture without affecting the nature of the present invention.

With reference now to FIG. 6b, there is shown a screen capture illustrating an initial working screen 650 of the exemplary remote infrastructure management system, CWIM, wherein a user of the exemplary remote infrastructure management system has a relatively low permission access level, according to a preferred embodiment of the present invention. The initial working screen 650 of the user with the relatively low permission access level may be similar to the initial working screen 600 of the user with the relatively high permission access level. However, due to the user's lower permission access level, there may be some functions that the user may not be able to perform. For example, the user may not be able to access the database 220 (via the database tools region 615 (FIG. 6a)). The initial working screen 600 displays the database tools region 615 while the initial working screen 650 does not. According to a preferred embodiment of the present invention, a user who is not permitted to perform a given task (due to his/her permission access level) may not see the option to perform the task on a working screen provided by the server 205. Furthermore, should a user attempt to access an unauthorized task, perhaps by accessing a cached working screen, a url (universal resource locator), or a bookmark, the remote infrastructure management system may notify the user of the improper access and may challenge the user to verify his/her identity.

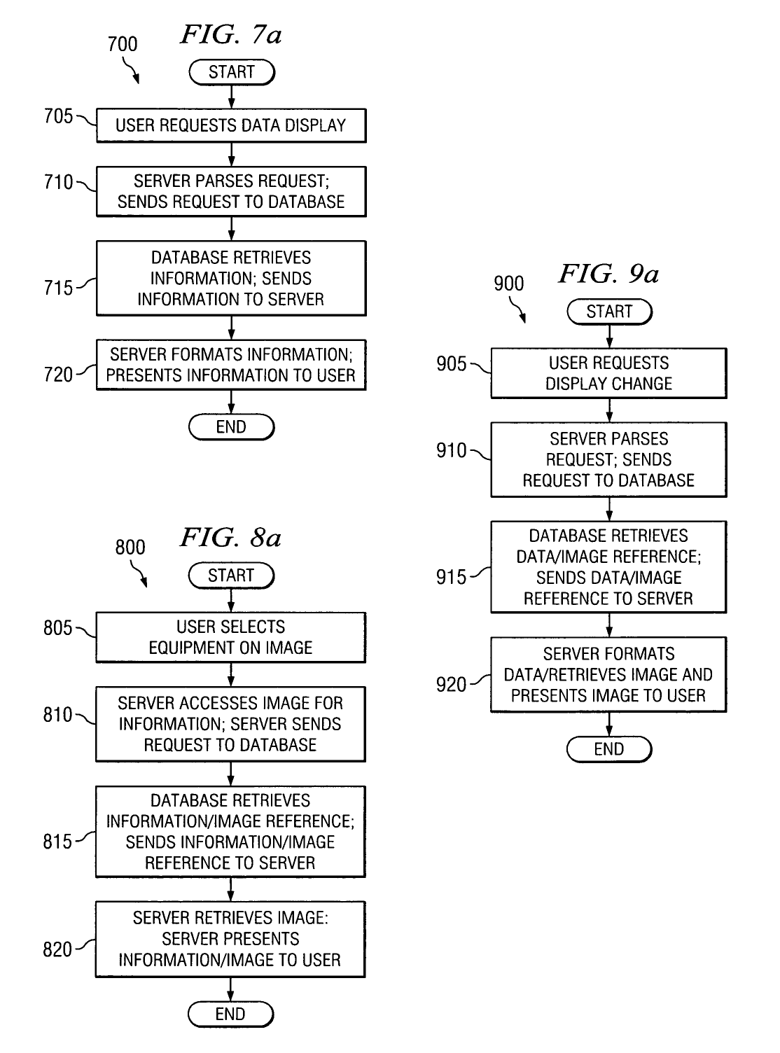

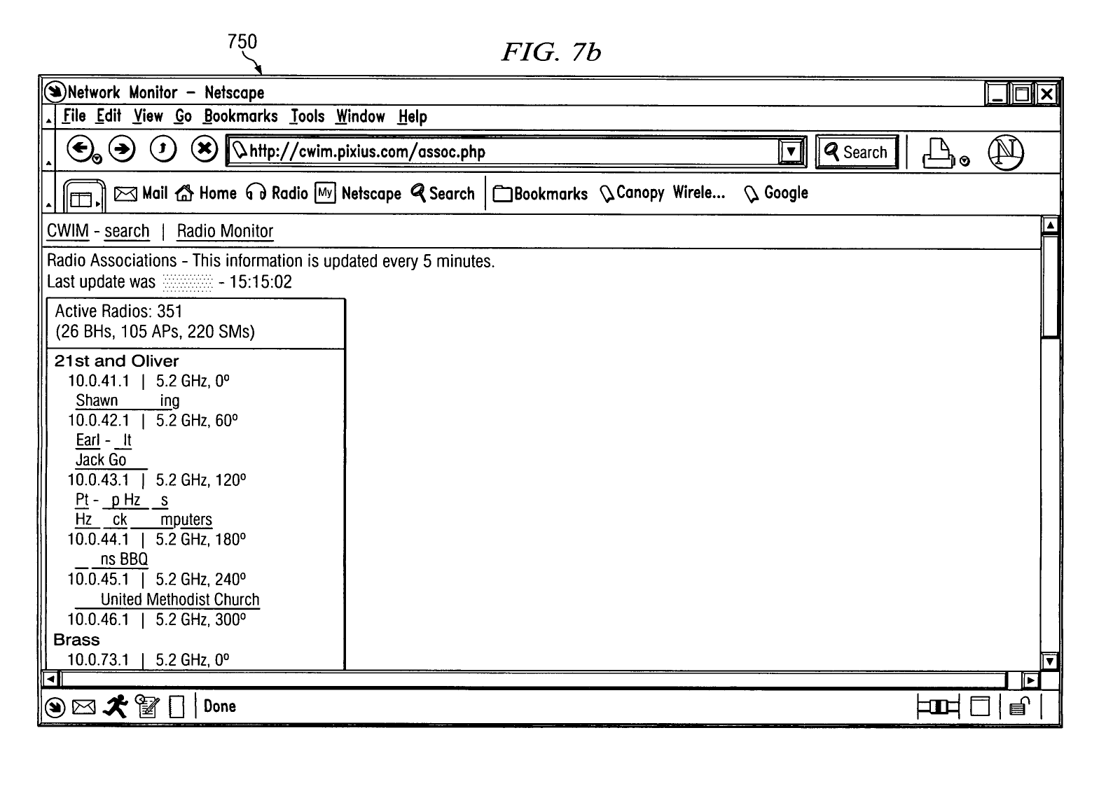

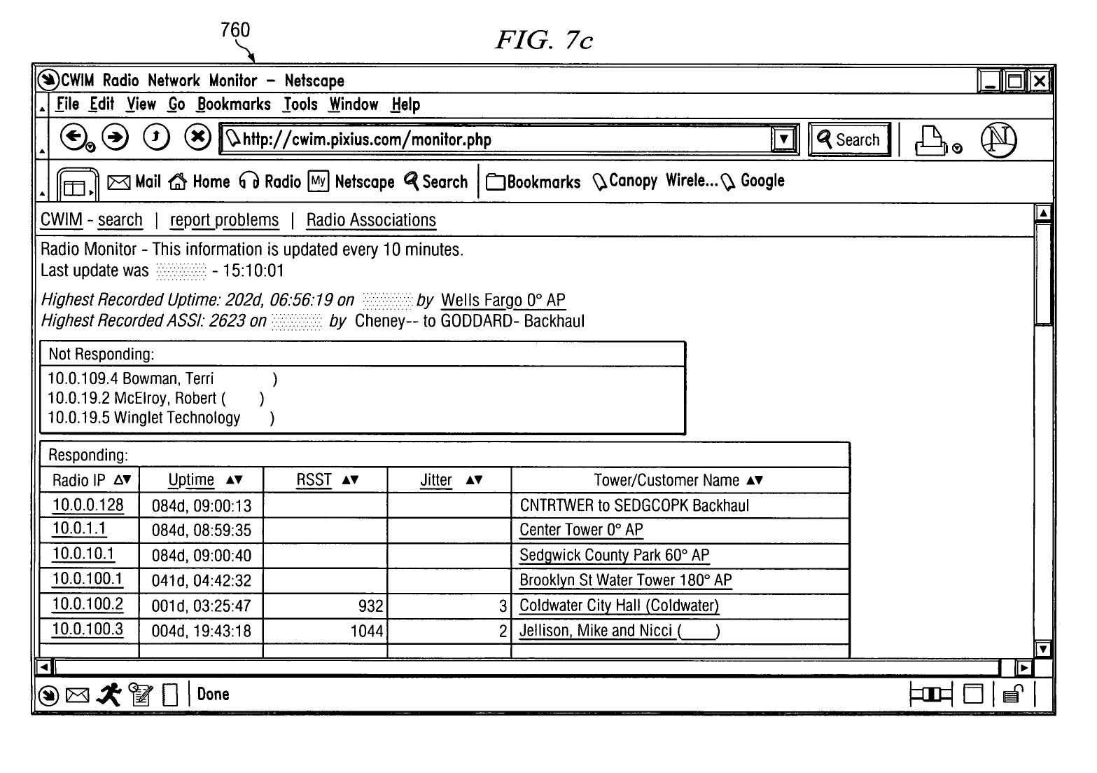

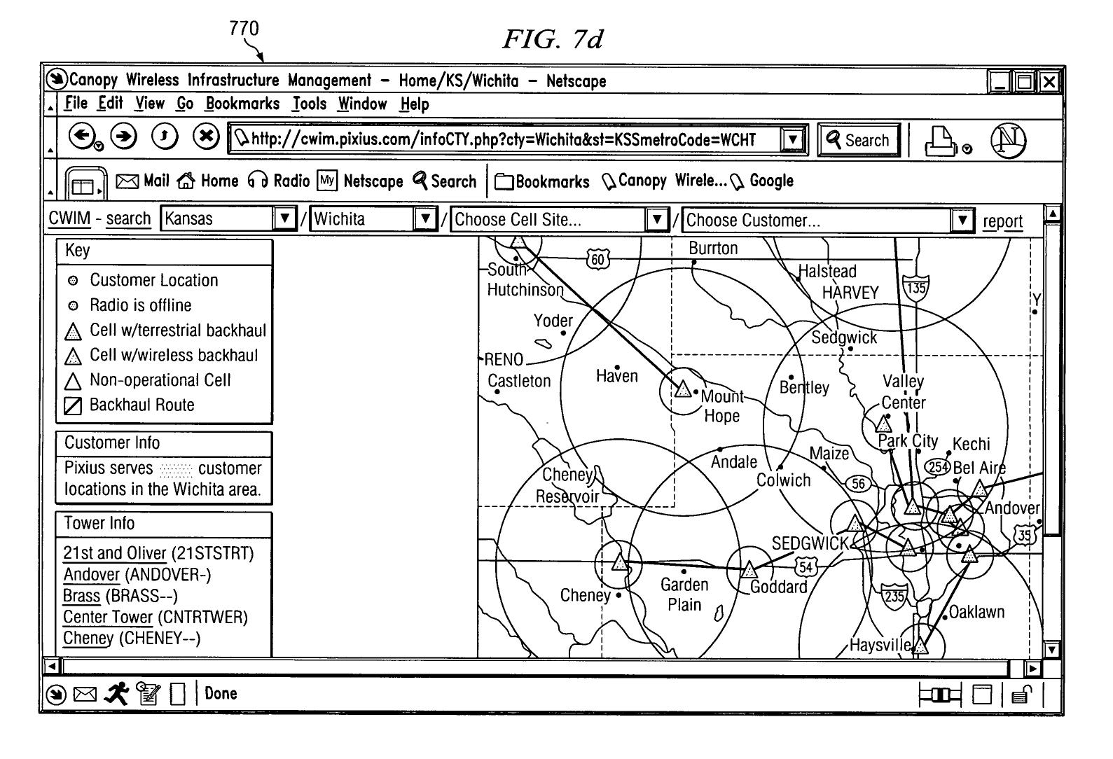

With reference now to FIG. 7a, there is shown a flow diagram illustrating a series of operations 700 in a request for information by a user, according to a preferred embodiment of the present invention. As displayed in FIG. 7a, the series of operations 700 can be representative of a request by the user for information concerning the infrastructure 210 along with operations taken by the remote infrastructure management system 300 to provide the information requested. Examples of information that can be requested by the user may include a list of associations for equipment in the infrastructure 210, status information for equipment in the infrastructure 210, information for equipment associated with a specific area, location, user, and so on.

The series of operations 700 can begin when the user requests that certain information be displayed (block 705). For discussion purposes, let the user request a list of associations for certain equipment (for example, radios) in the infrastructure 210. The server 205 can then parse the request and sends the request to the database 220 (block 710). According to a preferred embodiment of the present invention, information that can be stored in the database 220 can be periodically updated according to a schedule controlled by the server 205. For example, the server 205 may specify that the information related to associations for radios in the infrastructure 220 be updated every five (5) minutes. The server 205 can then schedule update requests for each radio to occur automatically every five minutes.

Upon receiving the request from the server 205, the database 220 can retrieve the requested information from its storage and may send the information to the server 205 (block 715). The server 205, upon receipt of the information from the database 220, can format the information according to a specified fashion (which may be specified by the user) and can present the information to the user, via a display device (block 720). Depending upon the type of information requested, the server 205 might elect to display the information in a tabular format or a graphical format. For graphical data, the server 205 may access images that can be stored on a dedicated server. Note that the dedicated server is not shown in FIG. 3. The dedicated server may be another web server, a file server, or so forth, that can be directly coupled to the server 205 (similar to the way the database 220 is coupled to the server 205 in FIG. 3) or it may be coupled to the server via a network, such as the Internet 305 (FIG. 3). The storage of image data on the dedicated server can reduce overhead for the database 220 so that the performance of the database 220 is not impacted. What may be stored in the database 220 may be image names (tags to specific images stored on the dedicated server), paths to the images, or specific locations of the images. Alternatively, the database 220 may also store the images so that additional network latency may not be incurred by the additional access to the dedicated server. Alternatively, the server 205 may generate images based upon the information provided by the database 220.

Note that the request from the user may be one of a sequence of requests. For example, the user may request a graphical view of infrastructure equipment installed at a specific location. The user may choose to continue to navigate to the specific location, beginning with a general location and continually refining the location until arriving at the specific location. For example, the user may first specify a country and obtain a graphical view of infrastructure equipment installed in the specified country. The user may then continue by specifying a state and obtaining a graphical view of infrastructure equipment installed in the specified state. The user can then continue by specifying a city, a neighborhood, a street, and so on. The sequence of operations 700 can be repeated until the user receives the desired information.

With reference now to FIG. 7b, there is shown a screen capture illustrating a screen 750 of the remote infrastructure management system, CWIM, in response to the user's request to provide a list of radio associations, according to a preferred embodiment of the present invention. To obtain a list of radio associations, the user can select “Radio Associations” from the network tools region 610 (FIGS. 6a and 6b). After the user makes the selection, the server 205 can direct the user to information pre-assembled with the list of radio associations. The pre-assembled information can be generated and then maintained by the server 205 as it receives information from the periodic network scans. Alternatively, after the user makes the selection, the server 205 can parse the selection and can pass a corresponding request to the database 220. The database 220 can then retrieve a list of radios in the infrastructure 210 along with their associations, which can include each radio's IP (Internet Protocol) address, operating frequency, and a list of customers connected to the radio, among other information, and provide the information to the server 205. Note that information regarding radios and their associations can be dynamic, therefore, periodic updates of the information may be in order. For example, updates can be performed once every five (5) minutes. As discussed previously, the server 205 may schedule periodic scanning of radios in order to maintain current information, with the results of the scanning being stored in the database 220. According to a preferred embodiment of the present invention, after receiving the information from the database 220, the server 205 can then format the information, turning it into a human-readable form, and provide it to the user via a display device.

With reference now to FIG. 7c, there is shown a screen capture illustrating a screen 760 of the remote infrastructure management system, CWIM, in response to the user's request to provide a radio status list, according to a preferred embodiment of the present invention. To obtain a ratio status list, the user can select “Radio Monitor” from the network tools region 610 (FIGS. 6a and 6b). After the user makes the selection, the server can parse the selection and pass a corresponding request to the database 220. The database 220 can then retrieve a list of radios in the infrastructure 210 along with their status information, which can include IP address, uptime, signal strength, and location, and provide the information to the server 205. The server 205 can then format the information and provide it to the user via a display device. Since radio status can change continually, the server 205 can maintain a list of status update requests. The list of status update requests can contain a list of requests to equipment in the infrastructure 210 (in this case, radios) that can be sent to the equipment, at the request's scheduled time, to obtain current status information. According to a preferred embodiment of the present invention, as long as the display device is displaying the radio status list, the server 205 can update the radio status list on the display device as updated radio status information (in response to the status update requests) is received.

With reference now to FIG. 7d, there is shown a screen capture illustrating a screen 770 of the remote infrastructure management system, CWIM, in response to the user's request to provide a graphical representation of equipment installed at a specified location, according to a preferred embodiment of the present invention. In order to retrieve a graphical representation of equipment installations at a specific location, the user can specify a location in the search region 620 (FIGS. 6a and 6b). The user can specify the location (for example, Wichita, Kans.) by first selecting a state (Kansas) and then a hub (Wichita) in the search region 620. After the user specifies the state (Kansas), the server 205 can access the database 220 to retrieve a list of possible hubs within the state (Kansas) and populates the search region 620 with the list of possible hubs. The server 205 can also retrieve a captured image of the state of Kansas along with a macroscopic view of portions of the infrastructure 210 installed in Kansas. The server 205 can display the retrieved image on the display device. The user can then select the hub (Wichita) from the search region 620 and the server 220 can access the database 220 to retrieve a list of equipment installed at the hub named Wichita in the state of Kansas along with a graphical image of the same. The server 205 can display the graphical image on the display device (FIG. 7d displays a screen capture of this graphical image). Since the user wanted to view equipment installed in Wichita, Kans., he/she may elect to stop. However, the user may continue to navigate down to more detailed views of installed equipment, should he/she desire. Alternatively, rather than sequentially navigating the search region 620 on a hierarchical basis (first selecting state then followed by selecting city and so forth), the user may be able to navigate directly to the desired location (Wichita, Kans.). As yet another alternative, if the user wishes to access a specific user, he/she can bypass the selecting of the ‘state,’ ‘hub,’ and so forth, and directly select the desired user in the search region 620.

The graphical images retrieved from the database 220 may be simple images of maps of the area. For example, the image of Wichita, Kans. can be an image file of the city purchased from one of several companies that sells maps. The database 220 can save the maps at different levels of granularity. For example, the database 220 may store a map of Kansas, a map of Wichita, a map of neighborhoods within Wichita, maps of certain streets within Wichita, and so on. According to a preferred embodiment of the present invention, infrastructure equipment can then be represented graphically on these maps. For example, a piece of equipment that is installed at a certain location can be represented graphically on a map via axial coordinates (such as X-axis and Y-axis coordinates) referenced to a point of origin on the map. This technique can be referred to as pixel mapping.

Alternatively, a more complex method using geographical data can be used to generate a graphical image of the equipment in the infrastructure 210. For example, each piece of equipment may have associated with it a piece of geographical data that can represent its location. An example of the geographical data may be a piece of equipment's longitude and latitude. Then, in response to a request to provide a graphical image of a certain location, the database 220 (or another entity that can be specialized in generating graphical images from geographical data) can retrieve the requested geographical data and generate the graphical image. This method can be more complex since the graphical images may be generated dynamically, which can place greater computational demands on a remote infrastructure management system. This method can also lead to greater storage requirements, resulting in a potentially more complex and expensive management system.

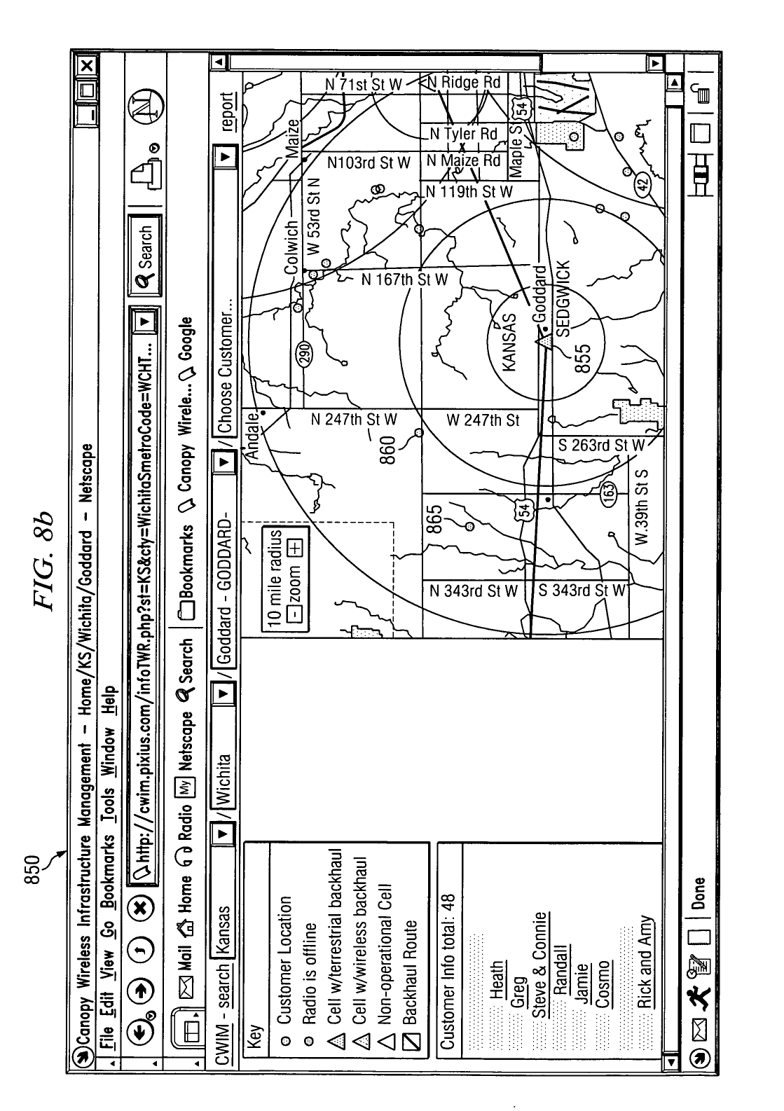

With reference now to FIG. 8a, there is shown a flow diagram illustrating a series of operations 800 in a request for information by a user, wherein the user selects an active portion of a graphical image displayed on a display device, according to a preferred embodiment of the present invention. According to a preferred embodiment of the present invention, portions of a graphical image being displayed on a display device may be active and can be used by the user to obtain additional information about the infrastructure 210. For example, equipment from the infrastructure 210 being graphically displayed on the display device may be active and when the user clicks on a representation of a piece of equipment, information about that equipment can be displayed. For example, if the user clicks on a graphical representation of a cell tower, information about the status of the tower can be displayed. Alternatively, if the user clicks upon a graphical representation of a transceiver, then information about a subscriber associated with the transceiver, perhaps including billing information can be displayed.

The series of operations 800 can begin when the user selects a graphical representation of a piece of equipment being displayed on a display device (block 805). The server 205 can access a stored version of a graphical image being displayed on the display device to determine the identity of the piece of equipment that the user selected (block 810). The piece of equipment can be identified by various unique identifiers, such as the equipment's media access control (MAC) address or some other unique identifier that may have been assigned to the equipment as they are being installed (or manufactured). Alternatively, the equipment may be identified based on their installation information, such as the subscriber's name (if it is a transceiver) or positional information for equipment not assigned to a subscriber. Upon determining the identity of the piece of equipment, the server 205 can send a request to the database 220 (also block 810).

The database 220 can then retrieve information regarding the selected piece of equipment and provide it to the server 205 (block 815). The information retrieved by the database 220 and sent to the server 205 can be information regarding the selected equipment or a reference to a graphical image or a combination of both. For example, if the user selected a cell tower, then the database 220 can provide a list of transceivers currently connected to the selected cell tower. Alternatively, the database 220 can provide a reference to a graphical image of the selected cell tower and the transceivers currently connected to the selected cell tower. If the database 220 provided a reference to a graphical image, the server 205 can retrieve the graphical image, which may be stored on a dedicated server (block 820). The dedicated server can be used to help reduce overhead demands on the database 220 to help maintain a desired level of performance. Alternatively, if the database 220 has sufficient performance capability, the graphical images may be stored on the database 220. The server 205 can then present the information to the user via the display device (block 820).

Note that the retrieval and/or display of the information associated with the selected piece of equipment can be dependent upon a configuration specified by the user (for example, the user may have specified the desire to be provided graphical representation of data) or on the nature of the equipment selected (for example, if the user selected a transceiver, then the only data that may be available for the transceiver may be text-based data concerning the status of the transceiver and the subscriber).

With reference now to FIG. 8b, there is shown a screen capture illustrating a screen 850 of the remote infrastructure management system, CWIM, in response to the user's selection of a graphical representation of a piece of equipment, according to a preferred embodiment of the present invention. As displayed in FIG. 8b, there is a graphical representation of a cell site 855, which may be referred to as “Goddard” (its installation location), along with transceivers (such as transceivers 860 and 865) communicating with the cell site 855. Note that color can be used to represent information. For example, transceiver 860 is displayed with a green color and transceiver 865 is displayed with a red color. This can be used to indicate that a problem is occurring with the transceiver 865. As discussed previously, the user can continue to select other equipment being displayed on the display device and obtain information about the equipment.

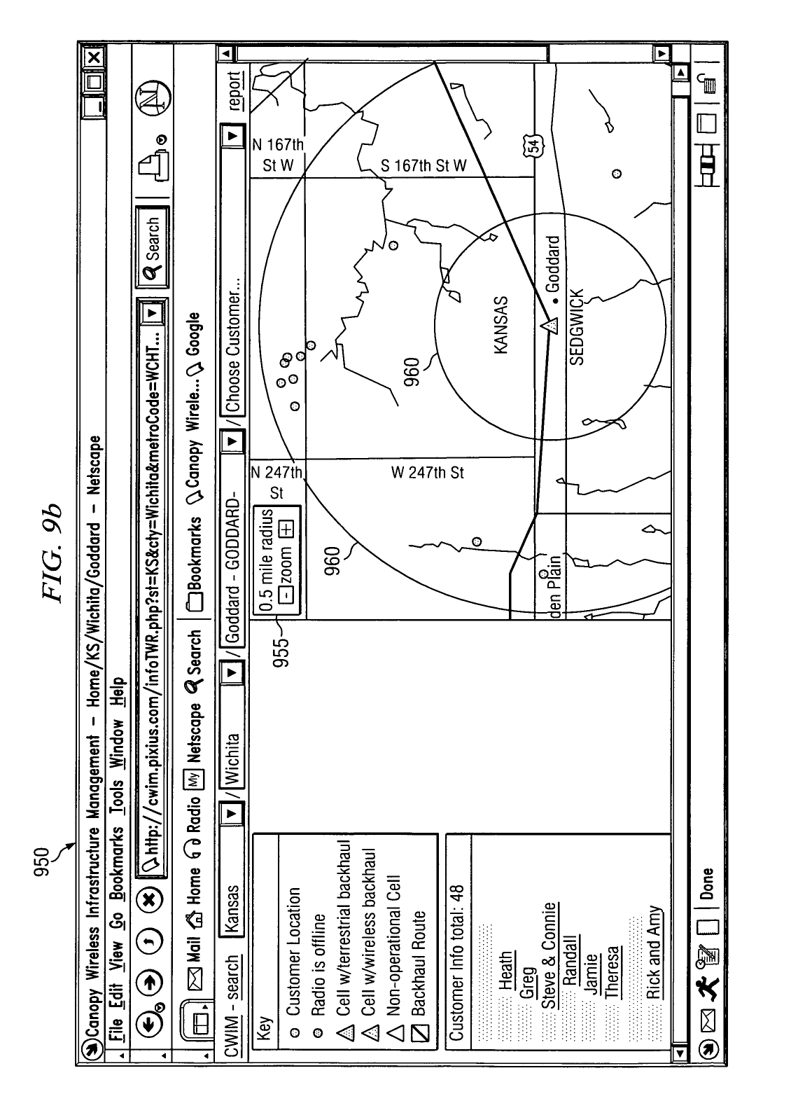

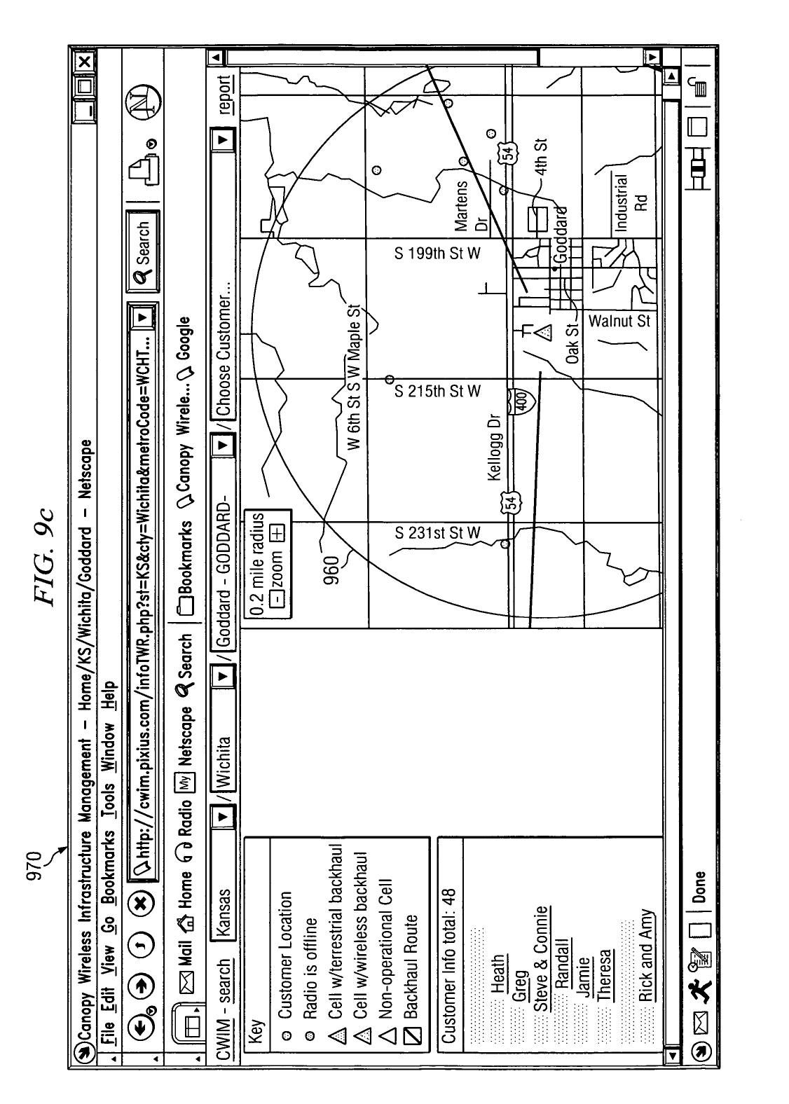

With reference now to FIG. 9a, there is shown a flow diagram illustrating a series of operations 900 in a request for display change by a user, wherein the user selects an active portion of a graphical image displayed on a display device, according to a preferred embodiment of the present invention. In addition to displaying graphical representations of infrastructure equipment, a graphical image that is displayed on the display device can contain controls that can be used by the user to change the information being displayed on the display device. The controls that can be included may include: zoom in/out, pan up/down/left/right, and so forth.

The series of operations 900 can begin when the user selects a display change control (block 905). As discussed previously, a display change control can result in a change in the graphical image being displayed on the display device. Examples of display changes can be, but are not limited to, changes in zoom and panning changes. The user may change the zoom by selecting a zoom in or zoom out button that can be a part of the graphical image displayed on the display device. Alternatively, the user may request a zoom into a specific portion of the graphical image by selecting distance indicators from certain equipment in the infrastructure 210, such as cell towers. The selection of a distance indicator can result in a change in the zoom so that the graphical image displays equipment that is less than the selected distance from the selected equipment. After the user selects the display change control (block 905), the server 205 can parse the request and pass the request to the database 220 (block 910). If the display change control is a part of the graphical image, then the server 205 may access a stored version of the graphical image to determine the change control selected by the user, in a manner that is similar to that as described in FIG. 8a. The database 220 can then retrieve data in response to the user's display change request and provide it to the server 205, which can then access the dedicated server to retrieve the graphical image (block 915). The server 205 can then provide the image to the user via the display device after performing any needed manipulation (block 920).

With reference now to FIG. 9b, there is shown a screen capture illustrating a screen 950 of a remote infrastructure management system, CWIM, in response to the user's selection to increase the zoom of the display, according to a preferred embodiment of the present invention. Prior to the user selecting the zoom in change control, the graphical image displayed on the display device may have the appearance of the screen capture 850 displayed in FIG. 8b. As a result of the user selecting the zoom in change control (similar to a zoom change control 955), the graphical image was changed to display a more detailed graphical image of infrastructure equipment around cell site “Goddard.” In addition to the zoom change control 955, other change controls may be available, such as distance arcs 960 and panning arrows (not shown).

With reference now to FIG. 9c, there is shown a screen capture illustrating a screen 970 of a remote infrastructure management system, CWIM, in response to the user's selection of a distance arc 960 around a cell site, according to a preferred embodiment of the present invention. According to a preferred embodiment of the present invention, a graphical image can have certain equipment, such as cell sites and hubs, that can have drawn around them arcs 960 that represent certain distances from the equipment. For example, cell sites and hubs may have distance arcs 960 drawn around them that are two (2), five (5), and ten miles from the equipment. The user can click on any of these distance arcs 960 and have the graphical image changed so that a new graphical image can be displayed with the hub and/or cell site becoming the center of the new graphical image and the zoom set so that equipment inside the selected distance arc is displayed. As discussed previously, the graphical images may be images purchased from a map source and stored in the dedicated server or the database 220. Alternatively, the graphical images can be dynamically generated during the course of operation.

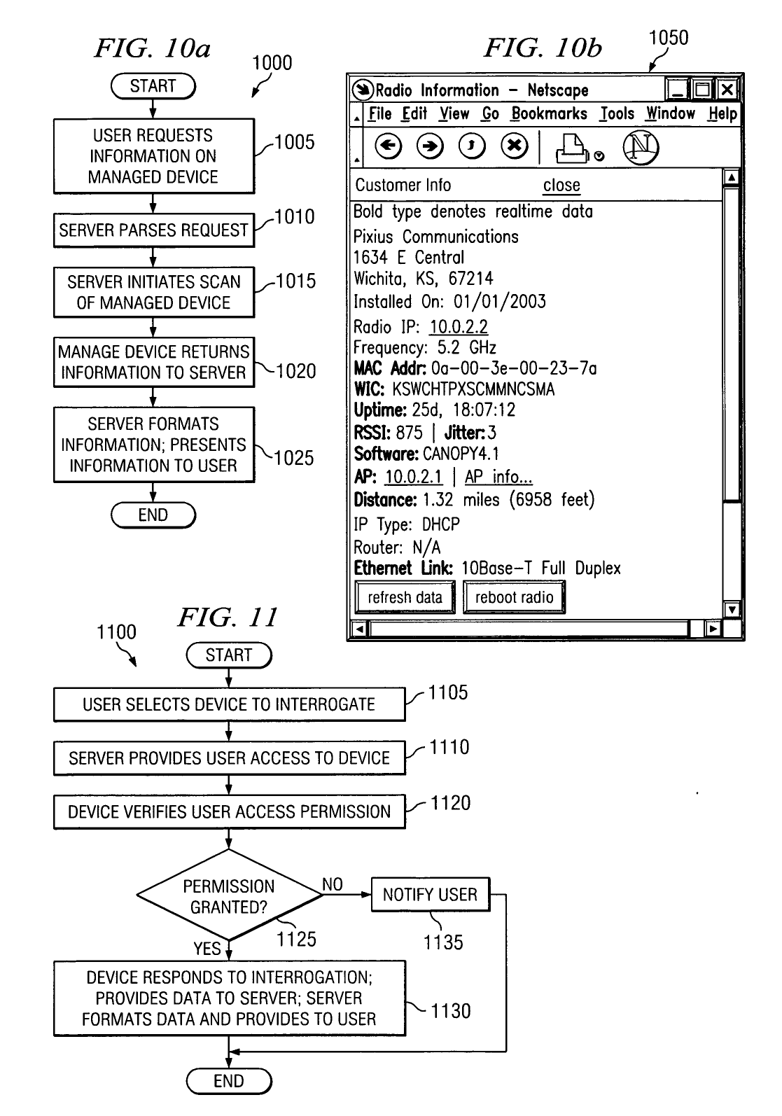

With reference now to FIG. 10a, there is shown a flow diagram illustrating a series of operations 1000 in a request of information from a managed piece of equipment (managed device), according to a preferred embodiment of the present invention. Previously, an information request by a user was discussed. That information request may have been for information about managed equipment or information stored in the database 220. The series of operations 1000 involves a direct request for information from a piece of equipment via a poll or scan of the equipment. This can be done to update information stored in the database 220 or to provide information to a user who is attempting to diagnose a performance problem in the equipment, for example.

The series of operations 1000 can begin when a user requests information on a managed piece of equipment (block 1005). Note that as discussed above, the series of operations 1000 can also be initiated automatically by scheduled polls/scans of managed equipment by the server 205, for example, to maintain updated information in the database 220. The server 205 receives the request (block 1010) and initiates a scan/poll of the equipment (block 1015). If the series of operations 1000 may have been initiated by the server 205, then block 1005 and 1010 may not be necessary. According to a preferred embodiment of the present invention, the scan/poll of the managed equipment can be performed using the Simple Network Management Protocol (SNMP). The SNMP can provide basic messages between a manager (such as the server 205) and agents (managed equipment in the infrastructure 210). It may be possible to use other communications protocols to perform the scan/poll of the managed equipment, including the custom design of a new protocol from scratch. An example of such a protocol can be PHP: Hypertext Preprocessor (PHP). In PHP, a “FILE( )” instruction can be used to read the contents of a managed equipment's file into an array.

After the managed equipment receives the scan/poll from the server 205, the managed equipment can return the requested information to the server 205, which in turn, can provide the information to the database 220 (block 1020). As discussed above, the information provided to the database 220 can be used to make sure that the database 220 is up to date. The server 205 can then format the information provided by the managed equipment into a form that can be readily understood by the user and presents it to the user via the display device (block 1025).

With reference now to FIG. 10b, there is shown a screen capture illustrating a screen 1050 of information provided by a managed piece of equipment in response to a scan/poll, according to a preferred embodiment of the present invention. The screen 1050 can contain up-to-date information from the managed piece of equipment, including the equipment's IP address, operating frequency, MAC address, uptime, signal strength, and so forth. Furthermore, the screen 1050 may contain buttons wherein the user can force an update of the information and so forth.

With reference now to FIG. 11, there is shown a series of operations 1100 in an interrogation of a managed piece of equipment by a user, wherein access verification is used, according to a preferred embodiment of the present invention. An interrogation may appear to be similar to an information request discussed above. However, an interrogation of managed equipment may occur between a user and the managed equipment while an information request may also occur between the server 205 and the managed equipment. Furthermore, an interrogation may require a verification access level since the interrogation may retrieve sensitive information. For example, a customer service representative may be prevented from changing the configuration of managed equipment, while a system architect may have full access to the configuration of the infrastructure 210. Additionally, an interrogation of the managed equipment may typically be performed between the user and the managed equipment with little or no intervention by the server 205.

The series of operations 1100 can begin with the user selecting the managed equipment to interrogate (block 1105). The selection of the managed equipment may also enable a list of items that can be interrogated, for example, certain memory locations, configuration parameters, and so on, which can vary depending upon type, make, and model of equipment. Once the user makes the interrogation (block 1105), the server 205 can parse the request and provide the user direct access to the managed equipment (block 1110). However, before the user can begin the interrogation of the managed equipment, the identity of the user may need to be verified (block 1120). As discussed previously, the identity of the user may be verified using a straight forward username and password combination or by biometric techniques. According to the preferred embodiment of the present invention, the managed device can verify the security access permission of the user, perhaps by accessing the database 220 or maintaining internally, a list of authorized users.

If the identity verification succeeds (block 1125), then the managed device can respond to the interrogation sent by the user (block 1130). This can involve sending information back to the user via the server 205, which can format the information prior to displaying the information on a display device (block 1130). If the identity verification fails (block 1125), then the user can be notified of the verification failure (block 1135) and may be permitted to try the identity verification again. Optionally, a security counter may be implemented to keep track of the number of times a user attempts to interrogate managed equipment and is rejected due to insufficient security access. If a specified number of rejected attempts have been exceeded, the user's account may be locked to prevent further attempts or an administrator may be notified of the attempts made by the unauthorized user.

While automated security access authorization can provide a level of security, if a user account with a high level of access has been breached, then the automated security access authorization may not provide a sufficient level of security. Identity verification, through user login with account name and password or biometric techniques, can be used to provide an additional level of security for the infrastructure 210. For example, this can prevent a situation wherein an unauthorized user gains access to the remote infrastructure management system when an authorized user forgets to logout.

Examples of managed equipment interrogation may be managed by the remote infrastructure management system 300 as shown above in FIG. 11 can include refresh and reboot operations, wherein the refresh operation can request up-to-date information from all of the managed equipment while the reboot operation can cause all of the managed equipment to be rebooted (reset). These types of interrogations can involve all managed equipment (or a type of managed equipment) and can be managed by the remote infrastructure management system 300. In this instance, the remote infrastructure management system 300 can perform an identity verification of the user making the request prior to issuing the scans of all managed equipment.

For other forms of managed equipment interrogation, namely, interrogation of single pieces of equipment for specific information, the remote infrastructure management system may not have direct control. With the exception of initiating the interrogation, the remote infrastructure management system may have no interaction with the user and the managed equipment being interrogated.

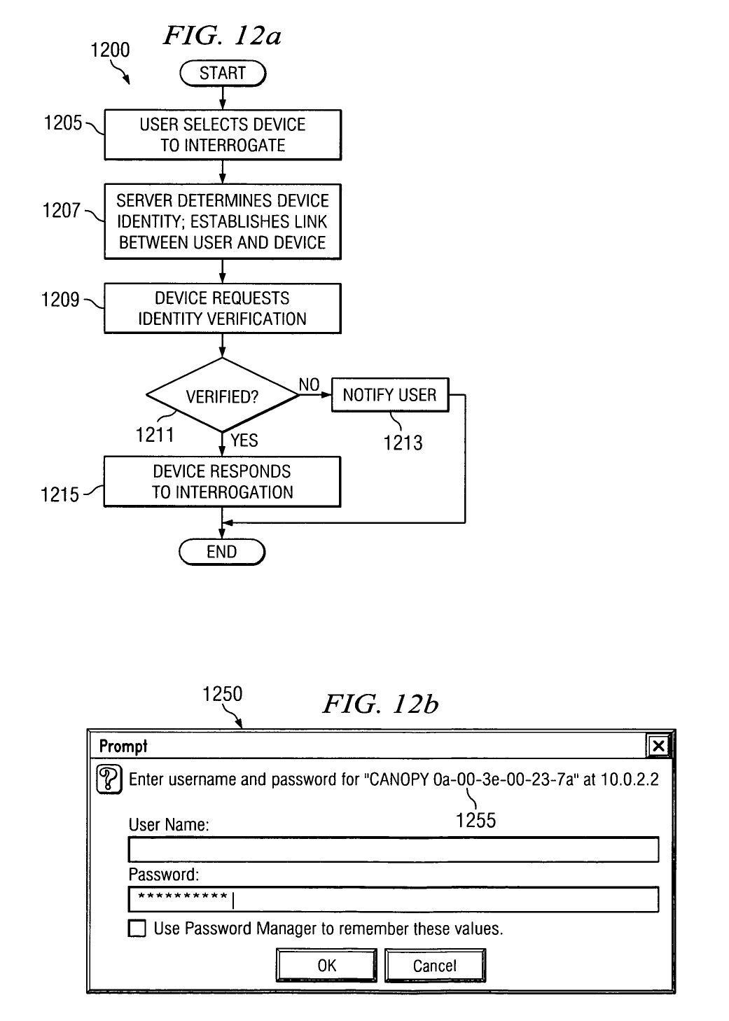

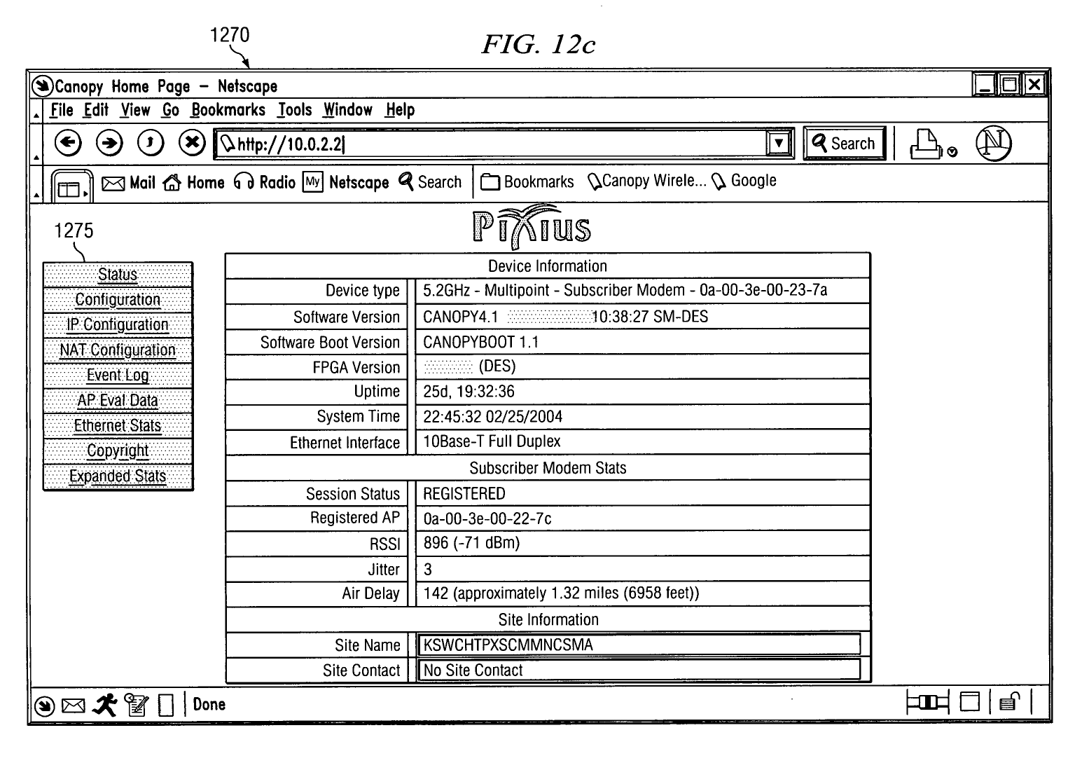

With reference now to FIG. 12a, there is shown a series of operations 1200 in an interrogation of a managed piece of equipment by a user, wherein identity verification is used, according to a preferred embodiment of the present invention. According to a preferred embodiment of the present invention, identity verification (either through account name and password, biometric techniques, or so forth) can be used in conjunction with security access verification to improve security in the remote infrastructure management system.

The series of operations 1200 can begin when the user selects the managed equipment to interrogate (block 1205). Once the user makes the interrogation (block 1205), the server 205 can determine the identity of the managed equipment, perhaps by parsing the graphical image for the selection of the user (block 1207). After determining the identity of the managed equipment that the user wishes to interrogate (block 1207), the server 205 can establish a direct link between the user and the managed equipment (block 1207). Note that this may involve the instantiation of another server (not shown) to format the information flowing between the user and the managed equipment.

When the managed equipment receives the interrogation, the managed equipment can send an identity verification request to the user (via the newly instantiated server) (block 1209). The user can be prompted for login information (account name and password, for example). After the user enters the login information, the login information can then be sent to the managed equipment for verification (block 1211). If the login information is not verified, then the login is denied and the user can be prompted to reenter the login information (block 1213). If the login information is verified, then the managed equipment can return the requested information to the user via the newly instantiated server (block 1215). The newly instantiated server can format the information in an easy to understand format and provide it to the user by way of the display device. Note that there may be interrogations that do not require identity verification. If this were the case, then after the link between the managed device and the user is established (block 1207), then the managed device can respond to the interrogation (block 1215).

Note that the identification verification described above used account name and password. It should be evident to those of ordinary skill in the art of the present invention that other identity verification techniques can be implemented with minor modifications to the sequence of operations 1200. Furthermore, the identity verification as shown in FIG. 12a occurs after the user's security access permissions have been checked. An alternate embodiment may involve performing the identity verification prior to the security access permission check.

With reference now to FIG. 12b, there is shown a screen capture illustrating an identity verification prompt 1250 for a remote infrastructure management system, CWIM, according to a preferred embodiment of the present invention. The identity verification prompt 1250 wherein the user is asked to enter his/her username (account name) and password. The identity verification prompt 1250 can be used to verify the identity of the user prior to permitting an interrogation of managed equipment identified as “CANOPY 0a-00-3e-00-23-7a” 1255 to proceed, wherein the identifier can be a unique name for the managed equipment. As described previously, the use of an account name and password is one of several methods that can be used to verify the user's identity. Other ways of verifying user identity may include biometric techniques and so forth. Note that since the identity verification may be performed by the managed device, which the remote infrastructure management system operating as a pass-through, the verification techniques and the appearance of the identity verification prompt may differ depending upon the managed device itself.

With reference now to FIG. 12c, there is shown a screen capture illustrating a screen 1270 containing information from a response to an interrogation of managed equipment for a remote infrastructure management system, CWIM, according to a preferred embodiment of the present invention. The screen 1270 shows information provided by managed equipment “CANOPY 0a-00-3e-00-23-7a” 1255 (FIG. 12b) in response to an interrogation from the user. Note that the information may have been formatted by the server 205 prior to being displayed. Additionally, the screen 1270 displays several actions 1275 that can be performed by the user, including viewing (and altering) the configuration (of the managed equipment), the IP configuration, NAT (network address translation) configuration, and so forth. According to a preferred embodiment of the present invention, since the identity of the user has been verified prior to the managed equipment providing the information displayed in the screen 1270, the identity of the user may need not be re-verified. However, if a certain amount of time expires between interrogations from the user, the managed equipment may require an identity verification operation, such as shown in FIG. 12b, to be repeated. The amount of time can be prespecified and may vary for different equipment in the infrastructure 210. Once again, since the interrogation takes place between the user and the managed device, the actual identity verification can differ depending upon the managed device.

As discussed previously, in order to maintain an up-to-date database 220, a remote infrastructure management system, such as CWIM, may need to automatically schedule scans/pools of equipment in the infrastructure 210, regardless of any interaction between a user and the equipment. The server 205 may be able to schedule the occurrence of the scans and then at the scheduled times, the server 205 can automatically perform the scans. The scans can be relatively simple information requests from the equipment in the infrastructure 210 since it may not be the intent of the server 205 to effect any changes in the equipment. However, since the number of equipment in the infrastructure 210 may be large, the periodic scans can consume a significant amount of time and network bandwidth, therefore, intelligent techniques may be applicable to help reduce the scan times and network bandwidth consumption.

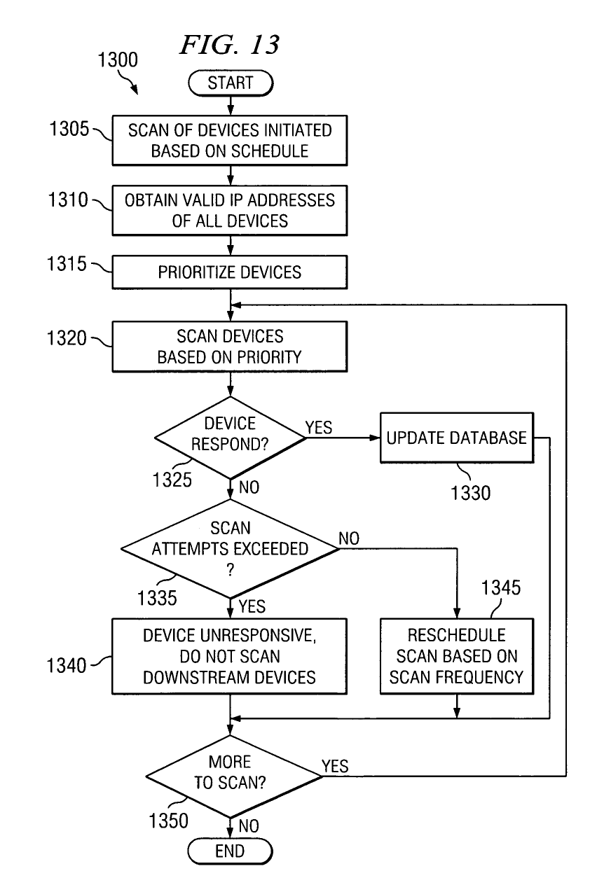

With reference now to FIG. 13, there is shown a flow diagram illustrating an algorithm 1300 for use in scheduling the scanning of equipment in the infrastructure 210, according to a preferred embodiment of the present invention. According to a preferred embodiment of the present invention, all of the equipment in the infrastructure 210 should be scanned periodically in order to maintain an up-to-date database 220. Note however, that different types of equipment can be scanned at different frequencies. For example, hubs, cell towers, and transceivers can all be scanned at different frequencies. Perhaps, hubs and cell towers, due to their relative importance and small numbers, may be scanned at a relatively high frequency and transceivers, due to their relatively low importance and large numbers, may be scanned at a relatively low frequency.

According to a preferred embodiment of the present invention, the server 205 can initiate a scan of devices based upon a predetermined schedule (block 1305). The schedule may be a simple specification of the frequency of the scans of the different types of equipment (network elements), for example. Alternatively, the schedule may specify the start times for the scans. The scan may begin by obtaining a list of valid IP addresses for the equipment of the equipment type being scanned, such as hubs, cell sites, and transceivers (block 1310). As an alternative to using IP addresses, another unique identifier may be used to list the equipment, such as MAC address, equipment name, and so on. According to a preferred embodiment of the present invention, the scan of the equipment in the infrastructure 210 may be performed by a scanning program that can be a part of the server 205. Alternatively, the scan can be performed by a separate entity designed to perform the scans independent of the server 205.

After obtaining a list of valid IP addresses, the list of equipment and their IP addresses may be prioritized (block 1315). According to a preferred embodiment of the present invention, hubs (backhauls) should be assigned the highest priority, followed by cell sites, and then transceivers. The hubs may then be partitioned into one of two types: root or child, wherein root hubs may be assigned a higher priority than child hubs. Root hubs are hubs that are connected to landlines (wired) and child hubs are hubs that are connected to wireless elements. After the prioritized list of equipment is complete, the scanning can begin, based upon the prioritized list (block 1320). A global value may be assigned for scan attempts and scan frequency. Alternatively, each equipment type (or individual piece) being scanned can be assigned a unique value for scan attempts and scan frequency. The scan attempt value can determine the number of failed scan attempts before the equipment is deemed unresponsive and the scan frequency value can determine the amount of time per scan attempt. For example, if scan attempt equals five (5) and scan frequency equals two (2), then the equipment can be scanned up to five times at a frequency of two seconds per scan.

If the equipment being scanned responds, then the equipment may be determined to be responsive (block 1325) and the response from the equipment can be used to update the database 220 (block 1330). However, if the equipment does not respond, then the equipment's scan attempts value can be checked to see if the number of times that the equipment has been scanned has exceeded the scan attempts value (block 1335). If the number of scans has exceeded the scan attempts value, then the equipment can be deemed to be unresponsive and equipment that is downstream to the unresponsive equipment should not be scanned (block 1340). The equipment that is downstream to the unresponsive equipment can have their scheduled scans (if any) removed from the schedule. The removal of equipment downstream from unresponsive equipment can result in a savings in the total scan time since devices that are at lower hierarchy than the unresponsive equipment are not going to be able to respond to the scan. For example, transceivers that are coupled to an unresponsive cell tower will not be able to receive the scan.

If the number of scans has not exceeded the scan attempts value (block 1335), then a scan of the equipment can be rescheduled based upon the scan frequency value (block 1345). For example, if the equipment's scan frequency value is two (2) seconds, then a scan for the equipment can be attempted for an additional two seconds. The equipment scan can continue by checking to see if additional scans need to be performed (block 1350). If additional scans are to be performed, the scan program can return to block 1320 to scan the next equipment on the prioritized list, else the scan program can terminate.

In addition to managing the infrastructure 210 and the equipment contained therein, a user may be able to configure the remote infrastructure management system 300, manage customer information and status, manipulate information contained in the database 220, configure and control user access and permissions, and so forth through the remote infrastructure management system 300. In other words, the user of the remote infrastructure management system 300 (with sufficient permission) can manage the remote infrastructure management system 300 through use of the remote infrastructure management system 300.

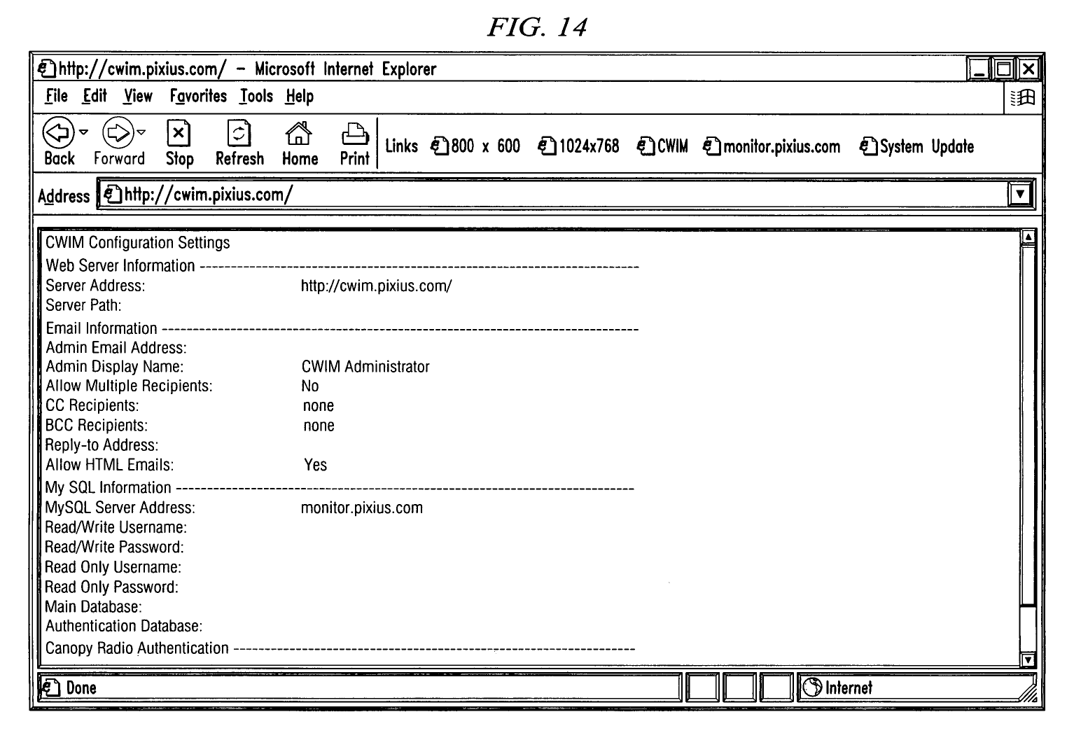

With reference now to FIG. 14, there is shown a screen capture illustrating a screen of configuration settings for a remote infrastructure management system, CWIM, according to a preferred embodiment of the present invention. FIG. 14 illustrates a screen of configuration settings for CWIM. Note that some sensitive information may have been obliterated in the screen capture without affecting the nature of the present invention. The configuration settings for CWIM include an address for the server 205, address for the database 220, authentication information for the infrastructure 210, and so forth. Not shown, but may be included in the configuration settings may be a way to change some (or all) of the configuration settings. For example, a different screen may present the user with an option to enter a configuration settings change mode. Entering this mode may likely require an identity verification.

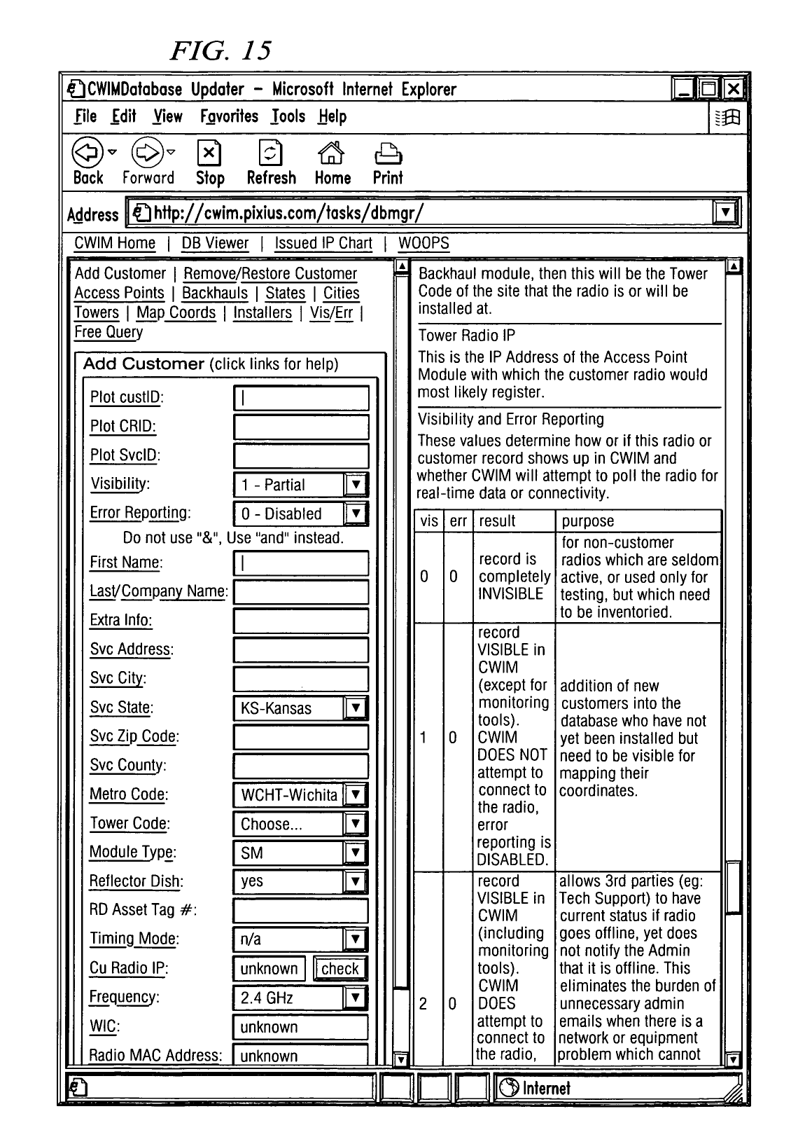

With reference now to FIG. 15, there is shown a screen capture illustrating a screen of customer information manipulation for a remote infrastructure management system, CWIM, according to a preferred embodiment of the present invention. FIG. 15 illustrates a screen that can be used to enter information for a customer (subscriber). The information that may be entered can include personal information, hardware information (including transceiver, cell tower, and hub information), and axial coordinates for use in locating the customer in graphical images (maps). In addition to adding new customers, the user can perform additional operations that may include removing and restoring existing customers, changing configurations for transceivers, cell towers, hubs, and so forth.

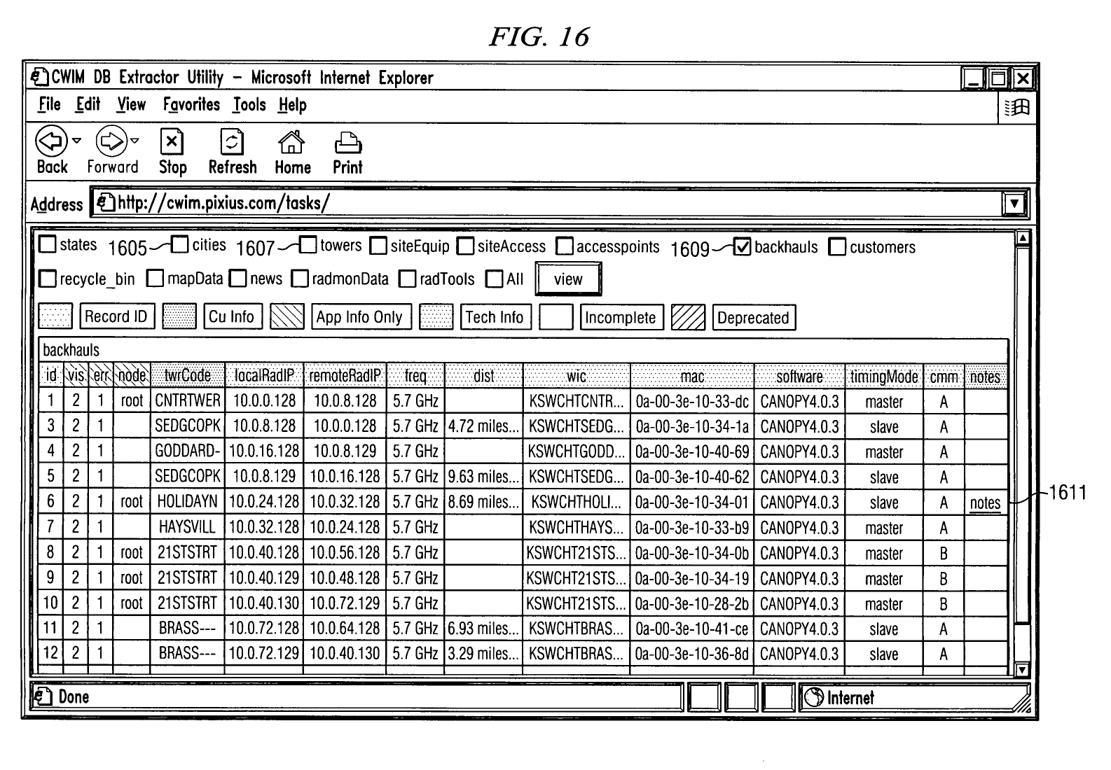

With reference now to FIG. 16, there is shown a screen capture illustrating a screen of information extracted from a database of a remote infrastructure management system, CWIM, according to a preferred embodiment of the present invention. FIG. 15 illustrates information extracted from a database (such as the database 220) based upon the selection of various criteria displayed across the top of the screen. For example, some of the criteria displayed across the top of the screen may be: cities 1605, towers (cell towers) 1607, and backhauls 1609. The information displayed in FIG. 16 is extracted from the database of CWIM when the backhauls 1609 criteria is checked. Note that the information displayed on the screen may be used to access additional information that may be available in the database 220. For example, if the data labeled “notes” 1611 is selected by the user, then additional information regarding backhaul with ‘twrCode’ “HOLIDAYN” can be displayed.

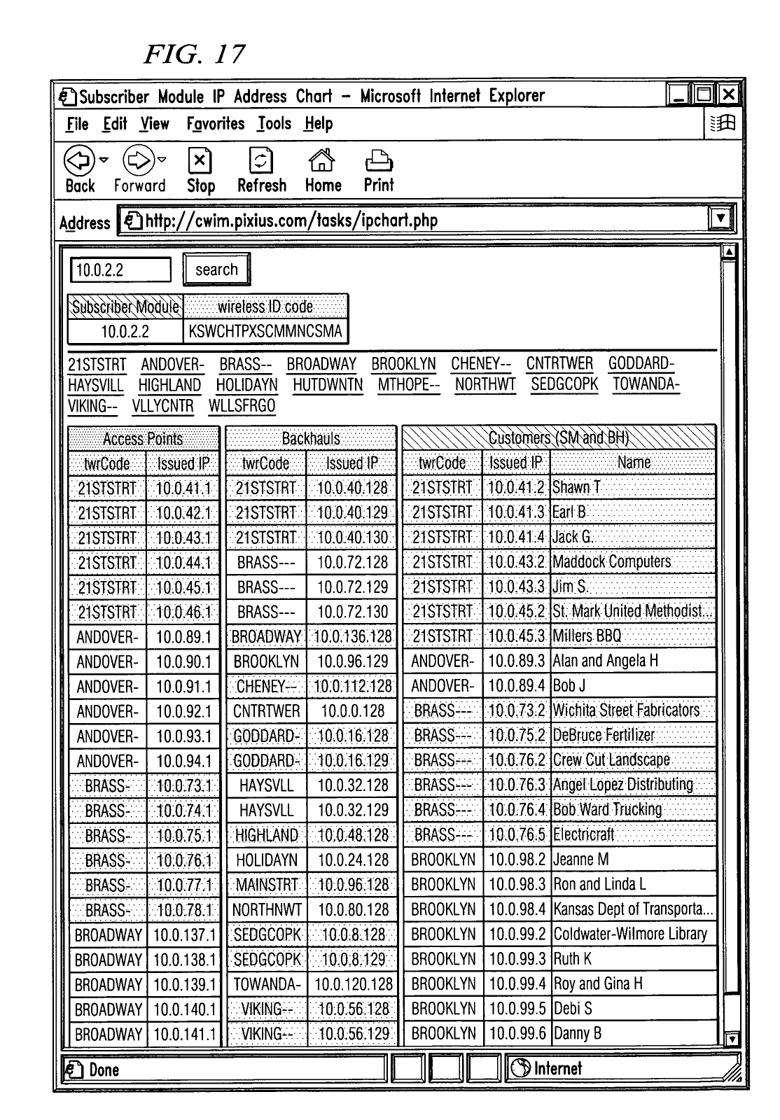

With reference now to FIG. 17, there is shown a screen capture illustrating a screen of search information from a database of a remote infrastructure management system, CWIM, according to a preferred embodiment of the present invention. In addition to extracting data from the database 220 through the use of certain criteria, such as shown in FIG. 16, the user can perform searches of the data stored in the database 220. FIG. 17 illustrates the result of a search in the database 220 for IP address “10.0.2.2.” The IP address 10.0.2.2 happens to be in this instance, the IP address for equipment operating in Wichita, Kans. Therefore, the database 220 returns information for hubs, cell towers, and transceivers operating in Wichita, Kans.

With reference now to FIG. 18, there is shown a screen capture illustrating a screen of update information of a remote infrastructure management system, CWIM, according to a preferred embodiment of the present invention. In addition to searching the database 220 for information, the user can post messages that can be displayed to other users. FIG. 18 displays a screen that can be used by a user to post messages that can be seen by other users. Note that in addition to having the posted information displayed for the other users when they are using CWIM, an email may be optionally sent to the users of CWIM to inform them of the posting. Furthermore, access to the update information screen may be limited to users with sufficient security access permission.

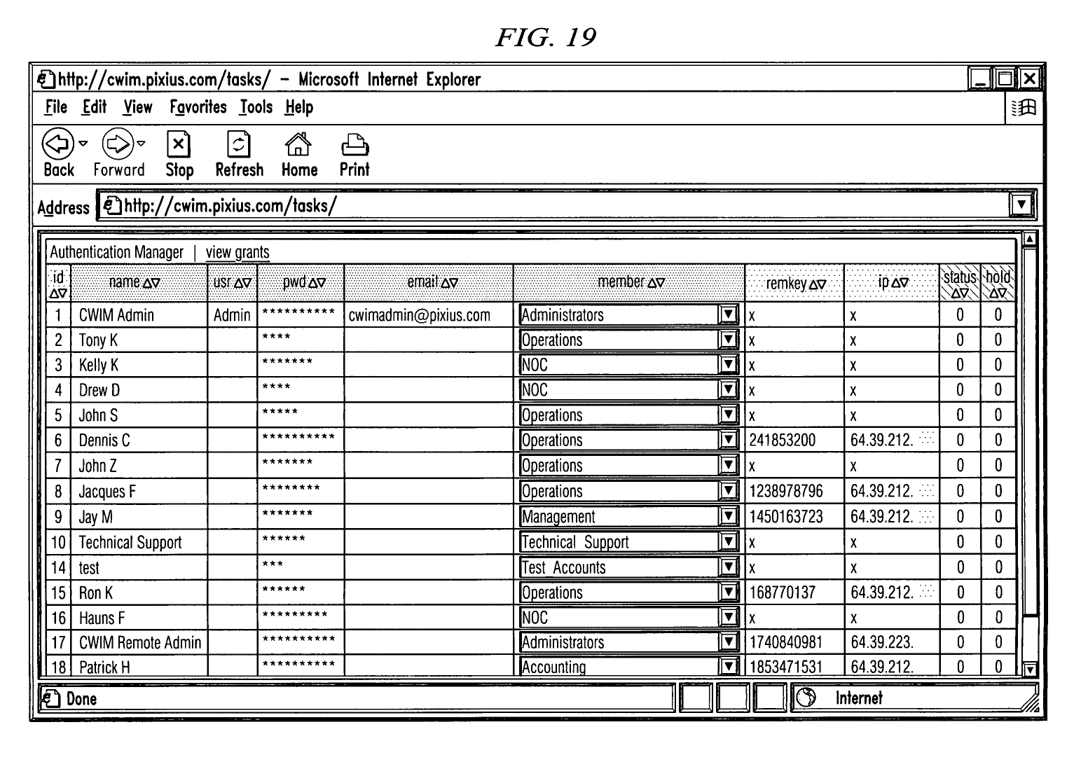

With reference now to FIG. 19, there is shown a screen capture illustrating a screen of user login information from a database of a remote infrastructure management system, CWIM, according to a preferred embodiment of the present invention. As discussed previously, the database 220 can be used to maintain user accounts and for identity verification of users. FIG. 19 illustrates a screen containing a plurality of user accounts stored in the database 220. According to a preferred embodiment of the present invention, the user account information stored in the database 220 may include user name, account name, password, email address, group membership, status, and so forth.

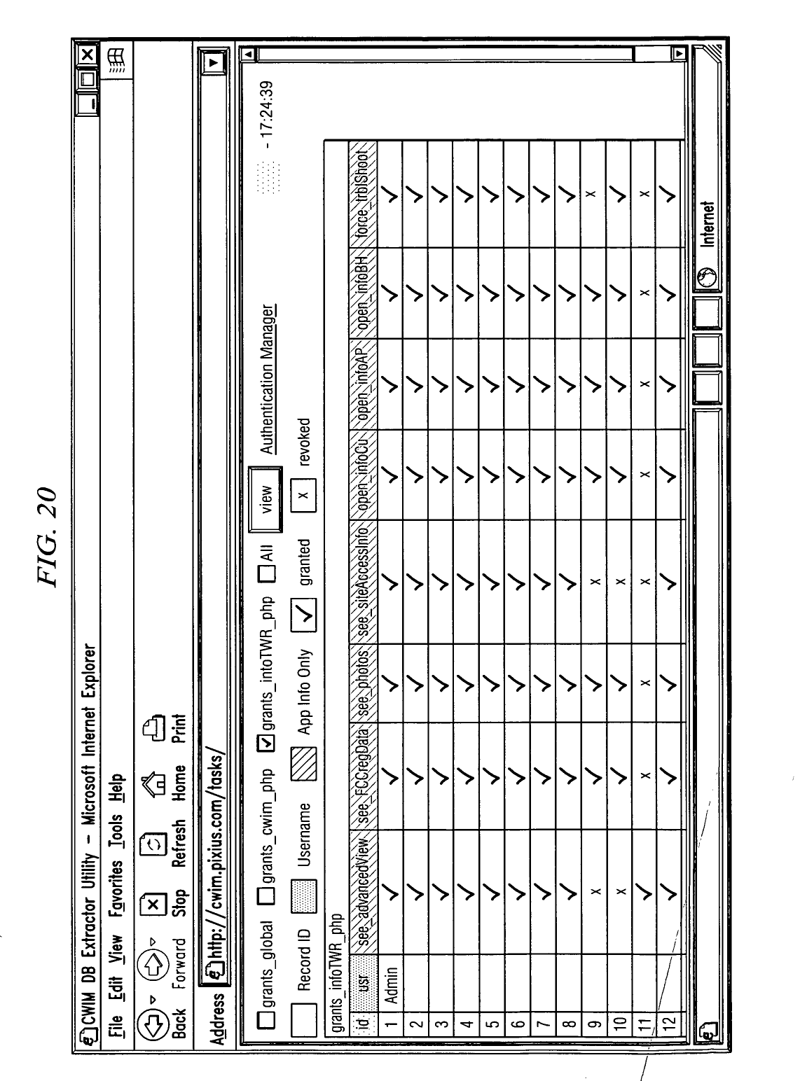

With reference now to FIG. 20, there is shown a screen capture illustrating a screen of user security access permissions from a database of a remote infrastructure management system, CWIM, according to a preferred embodiment of the present invention. FIG. 19 illustrates a screen containing user account information stored in the database 220. FIG. 20 illustrates a screen containing additional user account information stored in the database 220. In addition to user account information such as user name, account name, password, and so forth, the database 220 can contain a set of security access permissions for each user account. The security access permissions can specify what a user can and cannot do and can and cannot see in the remote infrastructure management system. For example, a low security user, such as a guest, may only be capable of seeing equipment status, but most likely cannot change equipment configurations nor can the user change user account information, while a system architect may have permission to see and change all aspects of the remote infrastructure management system.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A remote infrastructure management system comprising:
a server remotely coupled to a user, the server is configured to receive queries from the user, parse the queries, send the queries to a desired destination, and to transmit information provided in response to the queries back to the user;
an infrastructure remotely coupled to the server, the infrastructure comprising a plurality of network elements and a network for connecting the network elements; and
a database coupled to the server, the database is configured to store, retrieve, and search information pertaining to the infrastructure and the remote infrastructure management system.

2. The remote infrastructure management system of claim 1, wherein the server sends the queries to the infrastructure or the database depending upon the query.

3. The remote infrastructure management system of claim 1, wherein the server formats the response to the queries prior to providing the response to the user.

4. The remote infrastructure management system of claim 3, wherein the server provides the formatted response to the user in a raw-data format and a display device used by the user converts the raw-data format into a human readable form to the user.

5. The remote infrastructure management system of claim 3, wherein the server provides the formatted response to the user in a fully-formed format and a display device used by the user displays the fully-formed format to the user.

6. The remote infrastructure management system of claim 1, wherein the information in response to a query is automatically saved by the database.

7. The remote infrastructure management system of claim 1, wherein the server displays the information to the user via a display device.

8. The remote infrastructure management system of claim 7, wherein the server displays the information graphically.

9. The remote infrastructure management system of claim 8, wherein graphical images representing the infrastructure are stored in a graphic database.

10. The remote infrastructure management system of claim 9, wherein reference information to the graphical images are stored in the database.

11. The remote infrastructure management system of claim 8, wherein graphical images representing the infrastructure are stored in the database.

12. The remote infrastructure management system of claim 9, wherein the graphical images also convey status information for network elements in the infrastructure.

13. The remote infrastructure management system of claim 8, wherein graphical images representing the infrastructure are generated from data stored in the database.

14. The remote infrastructure management system of claim 8, wherein a network element that is performing improperly is highlighted by the server.

15. The remote infrastructure management system of claim 7, wherein the server displays the information textually.

16. The remote infrastructure management system of claim 7, wherein the server displays the information both graphically and textually.

17. The remote infrastructure management system of claim 1, wherein the database stores status information regarding the network elements in the infrastructure.

18. The remote infrastructure management system of claim 1, wherein the database stores configuration information for the remote infrastructure management system.

19. The remote infrastructure management system of claim 18, wherein the database stores user account information.

20. The remote infrastructure management system of claim 19, wherein the database stores user permission access information.

21. The remote infrastructure management system of claim 18, wherein the database stores descriptive information regarding the network elements in the infrastructure.

22. The remote infrastructure management system of claim 18, wherein the server stores documentation for the network elements.

23. The remote infrastructure management system of claim 18, wherein the server stores documentation for certain network elements.

24. The remote infrastructure management system of claim 1, wherein the server periodically schedules scans of the network elements in the infrastructure.

25. The remote infrastructure management system of claim 24, wherein the period of the periodic scans is the same for the network elements.

26. The remote infrastructure management system of claim 24, wherein there are different types of network elements, and wherein the period of the periodic scans differs for the different types of network elements.

27. The remote infrastructure management system of claim 24, wherein a change in the status of the network elements is automatically provided to the user.

28. The remote infrastructure management system of claim 1, wherein the user can access the system only after identity verification.

29. The remote infrastructure management system of claim 28, wherein the identity verification uses an account name and password.

30. The remote infrastructure management system of claim 28, wherein the identity verification uses biometric techniques.

31. The remote infrastructure management system of claim 28, wherein the identity verification information is stored on the database.

32. The remote infrastructure management system of claim 28, wherein the user's access to specific functionality in the system is based upon the user's security access level.

33. The remote infrastructure management system of claim 1, wherein the server and the database are remotely coupled.

34. The remote infrastructure management system of claim 1 further comprising a graphic server coupled to the server, the graphic server to contain graphical images of the infrastructure.

35. A method for infrastructure management comprising:
scanning network element status;
displaying the network element status;
alerting a user if a network element is operating improperly, wherein the user is at a location remote from the infrastructure; and
allowing the user to control the improperly operating network element.

36. The method of claim 35, wherein the scanning is performed periodically.

37. The method of claim 36, wherein the scanning period can vary for different network elements.

38. The method of claim 36, wherein the scanning period can vary for different types of network elements.

39. The method of claim 36, wherein the scanning comprises:
creating a prioritized scan list based upon network element type;
sending a scan message to a highest priority network element in the prioritized scan list;
processing scan results; and
repeating the sending and processing for remaining network elements in the prioritized scan list.

40. The method of claim 39, wherein the processing comprises:
saving the scan results if the network element responds to the scan message; and
adding a new scan of the network element to the prioritized scan list if the network element does not respond to the scan message.

41. The method of claim 40, wherein the adding occurs only if a number of times the network element has been sent a scan message is less than a specified threshold.

42. The method of claim 41, wherein the new scan of the network element is set for a specified time duration from a current time.

43. The method of claim 40, wherein if the number of times the network element has been sent a scan message is greater than the specified threshold, then the network element is unresponsive.

44. The method of claim 43, wherein if the network element is unresponsive, then network elements downstream from the unresponsive network element are removed from the prioritized scan list.

45. The method of claim 35, wherein the network element status is displayed graphically.

46. The method of claim 45, wherein the network element status is displayed on maps stored on a graphic server.

47. The method of claim 46, wherein the network elements are placed on the maps using axial coordinates.

48. The method of claim 46, wherein the maps are stored as image data.

49. The method of claim 35 further comprising after the allowing, dispatching a repair crew if after reconfiguring the improperly operating network element, the network element continues to operate improperly.

50. The method of claim 35, wherein the network element can be manually selected for scanning.

51. The method of claim 50, wherein a scan message can be sent to the selected network element.

52. The method of claim 51, wherein the displaying provides information about the selected network element.

53. The method of claim 51, wherein the displaying provides information about all network elements.

54. The method of claim 35, wherein the allowing involves the user remotely sending messages to the network element.

55. The method of claim 54, wherein the control of the network element is one or more selected of a group consisting of requesting configuration information, requesting contents of a memory location, setting configuration information, setting the content of a memory location, resetting the network element, rebooting the network element, powering off the network element.

56. The method of claim 35, wherein a network element is operating improperly if the network element has a performance parameter that does not meet a predetermined threshold.

57. The method of claim 56, wherein the performance parameter is one or more parameters selected from the following list: received signal strength indicator (RSSI), clock jitter, equipment uptime, session count, request to send (RTS) threshold, minimum contention window, average receive signal-to-noise ratio (SNR), data throughput, network latency, and link efficiency.

58. The method of claim 35, wherein a network element is operating improperly if the network element does not respond to a scan.

59. The method of claim 58, wherein a network element is operating improperly if the network element does not respond to a scan after a certain amount of time.

60. The method of claim 58, wherein a network element is operating improperly if the network element does not respond to a single scan out of a specified number of scans.

61. The method of claim 35, wherein the alerting comprises sending a message to the user.

62. The method of claim 35, wherein the alerting comprises triggering an alarm.

63. The method of claim 35, wherein the scanning is a result of a report made by a user of the infrastructure.

64. A method for scanning network elements, the method comprising:
creating a prioritized scan list based upon network element type;
sending a scan message to a highest priority network element in the prioritized scan list;
processing scan results; and
repeating the sending and processing for remaining network elements in the prioritized scan list.

65. The method of claim 64, wherein the processing comprises:
saving the scan results if the network element responds to the scan message; and
adding a new scan of the network element to the prioritized scan list if the network element does not respond to the scan message.

66. The method of claim 65, wherein the adding occurs only if a number of times the network element has been sent a scan message is less than a specified threshold.

67. The method of claim 66, wherein the new scan of the network element is set for a specified time duration from a current time.

68. The method of claim 65, wherein if the number of times the network element has been sent a scan message is greater than the specified threshold, then the network element is unresponsive.

69. The method of claim 68, wherein if the network element is unresponsive, then network elements downstream from the unresponsive network element are removed from the prioritized scan list.

70. A method for remote management of a communications network, the method comprising:
scanning network elements in the communications network;
processing the results of the scan;
alerting a user if a network element is operating improperly; and
allowing the user to control the improperly operating network element.

71. The method of claim 70, wherein the scanning is manually initiated.

72. The method of claim 71, wherein the scanning scans all network elements.

73. The method of claim 71, wherein the scanning scans a portion of the communications network.

74. The method of claim 70, wherein the scanning is performed automatically, and wherein the scanning scans all network elements.

75. The method of claim 70, wherein the scanning is the result of a subscriber reported performance problem.

76. The method of claim 75, wherein the scanning scans only the network element reported by the subscriber.

77. The method of claim 70, wherein the alerting comprises highlighting the improperly operating network element.
